(19) United States
(12) Patent Application Publication
(10) Pub. No.: US 2008/0212225 A1
(43) Pub. Date: Sep. 4, 2008

(54) INFORMATION PROCESSING APPARATUS, INFORMATION RECORDING MEDIUM, AND INFORMATION PROCESSING METHOD, AND COMPUTER PROGRAM

(75) Inventors: Ryogo ITO, Tokyo (JP); Fumihiko Kaise, Tokyo (JP); Junichi Yokota, Kanagawa (JP); Hiroshi Shimono, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/034,463

(22) Filed: Feb. 20, 2008

(30) Foreign Application Priority Data
Feb. 21, 2007 (JP) 2007-041456

(51) Int. Cl. G11B 15/18

(52) U.S. Cl. 360/71

(57) ABSTRACT

An information processing apparatus which executes formatting of an information recording medium includes a data processing section that executes formatting in which a plurality of partitions serving as a plurality of segmented data recording areas are set, and a partition-specific master boot record (MBR) dedicated to each of the partitions is recorded in each of the partitions.

### CROSS REFERENCES TO RELATED APPLICATIONS

The present invention contains subject matter related to Japanese Patent Application JP 2007-041456 filed in the Japanese Patent Office on Feb. 21, 2007, the entire contents of which are incorporated herein by reference.

### BACKGROUND OF THE INVENTION

1. Field of the Invention

The present invention relates to an information processing apparatus, an information recording medium, and an information processing method, and a computer program. More specifically, the present invention relates to an information processing apparatus, an information recording medium, and an information processing method, and a computer program which make it possible to perform recording or playback of information by setting partitions having different access permission configurations on an information recording medium.

2. Description of the Related Art

For example, in a digital video camera, a PC, or other such information processing equipment, an information recording or playback process using media (information recording medium) such as a hard disk is performed. One way of using such an information recording medium is to set partitions. For instance, by splitting the storage area of a hard disk in two to set two partitions, it is possible to realize a configuration in which a single hard disk is used as if there were two hard disks.

For example, there are following related art documents disclosing a method of setting or using partitions. For example, Japanese Unexamined Patent Application Publication No. 2002-202902 and Japanese Unexamined Patent Application Publication No. 2004-348195 describe a contrivance to set a plurality of partitions on media such as a hard disk, and a contrivance to set large-capacity partitions.

However, according to the configurations disclosed in these documents, basically, data in any partition can be recorded or played back without discrimination. That is, there is no difference in access permissibility between partitions. Japanese Unexamined Patent Application Publication No. 2004-213365 discloses a configuration in which a backup area is secured in the storage area of a single hard disk drive. In Japanese Unexamined Patent Application Publication No. 2004-213365, the backup area is set as an area with no logical formatting, and normal access is disabled to thereby realize protection of data. However, access to the storage area of backup data requires a special kind of access different from the normal access method.

Recorded data of manuals describing how to use a camera or the like, sample image data, or image processing applications is often set on storage means included in a digital camera, such as a hard disk, in advance prior to provision to the user. In the case of a PC or the like as well, various application programs are often recorded in advance prior to provision to the user.

In an information processing apparatus including an information recording medium having such recorded data, if such manuals and applications are set to be recorded in the same area as, for example, the user-data recording area for recording data (e.g., photographic data) generated by the user, important data including manuals is handled in the same manner as user data that can be freely recorded and deleted, so there is a risk of these important data being erroneously deleted by the user.

In the case of, for example, a camera or the like, manuals and image processing applications are important data that should not be erroneously deleted. Accordingly, it is desirable to prevent erroneous deletion of important data by setting different access permission configurations with respect to these important data and user data that can be freely recorded, played back, and deleted. However, there are also times when it is required to perform such a process as adding or updating new important data, and it is not preferable to increase the complexity of such a process.

### SUMMARY OF THE INVENTION

It is thus desirable to provide an information processing apparatus, an information recording medium, and an information processing method, and a computer program, in which a plurality of partitions are set on an information recording medium, a part of these partitions serves as a partition used for the recording/playback of user data, and a part of these partitions serves as a partition for recording important data other than user data, such as manuals, applications, and sample data, and the respective partitions are set so as to differ in access permissibility, thereby reducing the possibility of erroneous deletion of data recorded in the partition recording important data such as manuals, without increasing the complexity of such a process as recording, addition, and updating of important data.

According to an embodiment of the present invention, there is provided an information processing apparatus including: an application executing section that executes a data recording or playback process with respect to an information recording medium; an access control section that receives information-recording-medium-specifying information from an executing application in the application executing section, generates access information corresponding to the received information-recording-medium-specifying information, and presents the access information to the executing application; and a device driver that executes access to the information recording medium, in which the access control section performs a process of generating access information corresponding to the whole or only a part of a plurality of partitions set on the information recording medium and presenting the access information to the executing application, in accordance with the information-recording-medium-specifying information received from the executing application.

In the information processing apparatus according to an embodiment of the present invention, the access control section performs a process of presenting start address information, which varies in accordance with the information-recording-medium-specifying information received from the executing application, to the executing application.

In the information processing apparatus according to an embodiment of the present invention, the access control section performs a process of receiving the information-recording-medium-specifying information corresponding to the whole or a part of the partitions of the information recording medium as the information-recording-medium-specifying information from the executing application, and presenting start address information corresponding to the whole or a part of the partitions of the information recording medium to the executing application in accordance with the received information-recording-medium-specifying information.

In the information processing apparatus according to an embodiment of the present invention, the access control section performs a process of presenting a starting logical block address (LBA) corresponding to the whole or a part of the partitions of the information recording medium to the executing application as the start address information corresponding to the whole or a part of the partitions of the information recording medium.

In the information processing apparatus according to an embodiment of the present invention, the application executing section is capable of selecting as the executing application at least one of a recording application that executes data recording, a playback application that executes data playback, and a connection application that executes processing by external connection equipment, for each of the recording application, the playback application, and the connection application, the information-recording-medium-specifying information that can be used is set in advance, and the access control section performs a process of presenting start address information corresponding to the whole or a part of the partitions of the information recording medium to the executing application, in accordance with the information-recording-medium-specifying information specified by one of the recording application, the playback application, and the connection application.

In the information processing apparatus according to an embodiment of the present invention, for the playback application, the information-recording-medium-specifying information that can be used is set in advance in accordance with a playback category indicating the kind of data to be played back, and the access control section performs a process of presenting the start address information corresponding to the whole or a part of the partitions of the information recording medium to the executing application, in accordance with the information-recording-medium-specifying information determined in accordance with the playback category of the playback application.

In the information processing apparatus according to an embodiment of the present invention, for the connection application, the information-recording-medium-specifying information that can be used is set in advance in accordance with a process category indicating the kind of data to be processed, and the access control section performs a process of presenting the start address information corresponding to the whole or a part of the partitions of the information recording medium to the executing application, in accordance with the information-recording-medium-specifying information determined in accordance with the process category of the connection application.

In the information processing apparatus according to an embodiment of the present invention, the access control section performs a process of setting virtual media corresponding to the whole or only a part of the plurality of partitions set on the information recording medium and presenting the virtual media to the executing application, in accordance with the information-recording-medium-specifying information received from the executing application.

In the information processing apparatus according to an embodiment of the present invention, for each of the partitions of the information recording medium, a partition-specific master boot record (MBR) as partition-specific access information is set individually, and the access control section performs a process of, when presenting only a part of the partitions to the executing application in accordance with the information-recording-medium-specifying information received from the executing application, setting the virtual media including the partition-specific master boot record (MBR) and presenting the virtual media to the executing application.

In the information processing apparatus according to an embodiment of the present invention, the information processing apparatus further includes a storage section that stores partition layout information of the information recording medium, and the access control section executes an updating process of the partition layout information recorded in the storage section when changing partition layout of the information recording medium.

In the information processing apparatus according to an embodiment of the present invention, the partition layout information recorded in the storage section includes information that allows calculation of a start address and partition size of each of the partitions set on the information recording medium, and the access control section performs a process of generating the access information by applying the partition layout information recorded in the storage section, and presenting the access information to the executing application.

According to an embodiment of the present invention, there is provided an information recording medium including: a plurality of partitions serving as a plurality of data recording areas; and a partition-specific master boot record (MBR) dedicated to each of the partitions, in which the information recording medium allows access using information recorded in the partition-specific master boot record (MBR).

In the information recording medium according to an embodiment of the present invention, the partition-specific master boot record (MBR) records a partition table for only a corresponding partition which records a start sector address and size information of the corresponding partition.

According to an embodiment of the present invention, there is provided an information processing apparatus which executes formatting of an information recording medium, including a data processing section that executes formatting in which a plurality of partitions serving as a plurality of segmented data recording areas are set, and a partition-specific master boot record (MBR) dedicated to each of the partitions is recorded in each of the partitions.

In the information processing apparatus according to an embodiment of the present invention, the data processing section executes a process of recording in the partition-specific master boot record (MBR) a partition table for only a corresponding partition which records a start sector address and size information of the corresponding partition.

According to an embodiment of the present invention, there is provided an information processing method for executing access control with respect to an information recording medium in an information processing apparatus, including: an application executing step of causing an application executing section to execute a data recording or playback process with respect to the information recording medium; and an access control step of causing an access control section to receive information-recording-medium-specifying information from an executing application in the application executing step, generate access information corresponding to the received information-recording-medium-specifying information, and present the access information to the executing application, in which the access control step performs a process of generating access information corresponding to the whole or only a part of a plurality of partitions set on the information recording medium and presenting the access information to the executing application, in accordance with the information-recording-medium-specifying information received from the executing application.

In the information processing method according to an embodiment of the present invention, the access control step performs a process of presenting start address information, which varies in accordance with the information-recording-medium-specifying information received from the executing application, to the executing application.

In the information processing method according to an embodiment of the present invention, the access control step performs a process of receiving the information-recording-medium-specifying information corresponding to the whole or a part of the partitions of the information recording medium as the information-recording-medium-specifying information from the executing application, and presenting start address information corresponding to the whole or a part of the partitions of the information recording medium to the executing application in accordance with the received information-recording-medium-specifying information.

In the information processing method according to an embodiment of the present invention, the access control step performs a process of presenting a starting logical block address (LBA) corresponding to the whole or a part of the partitions of the information recording medium to the executing application as the start address information corresponding to the whole or a part of the partitions of the information recording medium.

In the information processing method according to an embodiment of the present invention, the application executing step is a step of selecting and executing as the executing application at least one of a recording application that executes data recording, a playback application that executes data playback, and a connection application that executes processing by external connection equipment, and for each of the recording application, the playback application, and the connection application, the information-recording-medium-specifying information that can be used is set in advance, and the access control step performs a process of presenting start address information corresponding to the whole or a part of the partitions of the information recording medium to the executing application, in accordance with the information-recording-medium-specifying information specified by one of the recording application, the playback application, and the connection application.

In the information processing method according to an embodiment of the present invention, for the playback application, the information-recording-medium-specifying information that can be used is set in advance in accordance with a playback category indicating the kind of data to be played back, and the access control step performs a process of presenting the start address information corresponding to the whole or a part of the partitions of the information recording medium to the executing application, in accordance with the information-recording-medium-specifying information determined in accordance with the playback category of the playback application.

In the information processing method according to an embodiment of the present invention, for the connection application, the information-recording-medium-specifying information that can be used is set in advance in accordance with a process category indicating the kind of data to be processed, and the access control step performs a process of presenting the start address information corresponding to the whole or a part of the partitions of the information recording medium to the executing application, in accordance with the information-recording-medium-specifying information determined in accordance with the process category of the connection application.

In the information processing method according to an embodiment of the present invention, the access control step performs a process of setting virtual media corresponding to the whole or only a part of the plurality of partitions set on the information recording medium and presenting the virtual media to the executing application, in accordance with the information-recording-medium-specifying information received from the executing application.

In the information processing method according to an embodiment of the present invention, for each of the partitions of the information recording medium, a partition-specific master boot record (MBR) as partition-specific access information is set individually, and the access control step performs a process of, when presenting only a part of the partitions to the executing application in accordance with the information-recording-medium-specifying information received from the executing application, setting the virtual media including the partition-specific master boot record (MBR) and presenting the virtual media to the executing application.

In the information processing method according to an embodiment of the present invention, the information processing apparatus has a storage section that stores partition layout information of the information recording medium, and the information processing method further includes a step of executing an updating process of the partition layout information recorded in the storage section when changing partition layout of the information recording medium.

In the information processing method according to an embodiment of the present invention, the partition layout information recorded in the storage section includes information that allows calculation of a start address and partition size of each of the partitions set on the information recording medium, and the access control step performs a process of generating the access information by applying the partition layout information recorded in the storage section, and presenting the access information to the executing application.

According to an embodiment of the present invention, there is provided an information processing method for executing formatting of an information recording medium in an information processing apparatus, including a data processing step of causing a data processing section to execute formatting in which a plurality of partitions serving as a plurality of segmented data recording areas are set, and a partition-specific master boot record (MBR) dedicated to each of the partitions is recorded in each of the partitions.

In the information processing method according to an embodiment of the present invention, the data processing section records in the partition-specific master boot record (MBR) a partition table for only a corresponding partition which records a start sector address and size information of the corresponding partition.

According to an embodiment of the present invention, there is provided a computer program for causing access control with respect to an information recording medium to be executed in an information processing apparatus, including: an application executing step of causing an application executing section to execute a data recording or playback process with respect to the information recording medium; and an access control step of causing an access control section to receive information-recording-medium-specifying information from an executing application in the application executing step, generate access information corresponding to the received information-recording-medium-specifying information, and present the access information to the executing application, in which the access control step performs a process of causing access information corresponding to the whole or a part of a plurality of partitions set on the information recording medium to be generated and presented to the executing application, in accordance with the information-recording-medium-specifying information received from the executing application.

According to an embodiment of the present invention, there is provided a computer program for causing formatting of an information recording medium to be executed in an information processing apparatus, including a data processing step of causing a data processing section to execute formatting in which a plurality of partitions serving as a plurality of segmented data recording areas are set, and a partition-specific master boot record (MBR) dedicated to each of the partitions is recorded in each of the partitions.

It should be noted that the computer program according to an embodiment of the present invention is a computer program that can be provided with respect to a general purpose computer system capable of executing a variety of program codes via a recording medium or communication medium that is provided in a computer-readable format, for example, a recording medium such as a CD, FD, or MO, or via a communication medium such as a network. By providing such a program in a computer-readable format, a process corresponding to that program is realized on the computer system.

Other objects, features, and advantages of the present invention will become apparent from the following detailed description of embodiments of the present invention and the accompanying drawings. It should be noted that the term system as used in this specification refers to a logical assembly of a plurality of apparatuses, and is not limited to one in which respective apparatuses are located within the same housing.

According to an embodiment of the present invention, a configuration is realized where a partition within the information recording medium to which access is permitted can be varied in accordance with the application executed in the information processing apparatus, for example, a recording application, a playback application, or an external-equipment connection application. For example, the access control section changes access information such as the start address in accordance with the application, and provides the access information to the application. According to this configuration, it is possible to perform access control according to the application to the executing application by, for example, disabling access from the recording application to data whose erroneous deletion should be prevented, such as a manual.

### BRIEF DESCRIPTION OF THE DRAWINGS

FIGS. 1A and 1B are diagrams illustrating the structures of data formatted in FAT16 and FAT 32b;

FIGS. 2A and 2B are diagrams illustrating the data structure of a master boot record (MBR);

FIG. 3 is a diagram illustrating the information structure of a directory entry;

FIG. 4 is a diagram illustrating an example of the data structure of a typical file allocation table (FAT);

FIG. 5 is a diagram showing an example of the format configuration of an information recording medium according to an embodiment of the present invention;

FIGS. 6A to 6C are diagrams showing an example of the data structure of the master boot record (MBR) shown in FIG. 5;

FIGS. 7A to 7C are diagrams showing an example of the data configuration of MBR1, 120 that is a master boot record (MBR) dedicated to a first partition shown in FIG. 5;

FIGS. 8A to 8C are diagrams showing an example of the data configuration of MBR2, 130 that is a master boot record (MBR) dedicated to a second partition shown in FIG. 5;

FIG. 9 is a diagram illustrating the system configuration of an information processing apparatus according to an embodiment of the present invention;

FIG. 10 is a diagram illustrating the system configuration of an information processing apparatus according to an embodiment of the present invention;

FIGS. 11A to 11C are diagrams illustrating a specific example of access control in a case where a recording application is executed in an information processing apparatus according to an embodiment of the present invention;

FIGS. 12A to 12C are diagrams illustrating a specific example of access control in a case where a playback application is executed in an information processing apparatus according to an embodiment of the present invention;

FIGS. 13A to 13C are diagrams illustrating a specific example of access control in a case where a playback application is executed in an information processing apparatus according to an embodiment of the present invention;

FIGS. 14A to 14C are diagrams illustrating a specific example of access control in a case where a USB connection application is executed in an information processing apparatus according to an embodiment of the present invention;

FIGS. 15A to 15C are diagrams illustrating a specific example of access control in a case where a USB connection application is executed in an information processing apparatus according to an embodiment of the present invention;

FIG. 16 is a diagram showing a flow chart illustrating a mounting process sequence for an information recording medium (media);

FIGS. 17A and 17B are diagrams illustrating devices that can be specified by applications;

FIG. 18 is a diagram showing a flow chart illustrating a mounting process sequence for an information recording medium (media);

FIGS. 19A to 19C are diagrams illustrating a device configuration presented to an application;

FIG. 20 is a diagram illustrating an example of partition layout information stored in a non-volatile memory;

FIG. 21 is a diagram showing a flow chart illustrating the control sequence of an information write or read process with respect to media (information recording medium);

FIG. 22 is a diagram showing a flow chart illustrating the sequence of a startup process;

FIG. 23 is a diagram showing a flow chart illustrating the sequence of an updating process of partition layout information;

FIG. 24 is a diagram showing a flow chart illustrating the sequence of a termination process;

FIG. 25 is a diagram illustrating a read-only flag;

FIG. 26 is a diagram showing a flow chart illustrating a sequence of determining whether or not writing of data is permitted or not by referring to a flag, when a data write command is inputted from an application;

FIG. 27 is a diagram illustrating an example of the configuration of a digital video camera as an information processing apparatus according to an embodiment of the present invention; and

FIG. 28 is a diagram illustrating an example of the configuration of a PC according to an embodiment of the present invention.

### DESCRIPTION OF THE PREFERRED EMBODIMENTS

Hereinbelow, an information processing apparatus, an information recording medium, and an information processing method, and a computer program according to an embodiment of the present invention will be described with reference to the drawings. The description will be made in the following order of topics.

1. Overview of File System

2. Example of Data Recording Configuration of Information Recording Medium according to Embodiment of Present Invention

3. Example of Configuration and Processing of Information Processing Apparatus

4. Details of Sequence of Process executed by Information Processing Apparatus

5. Example of Hardware Configuration of Information Processing Apparatus

[1. Overview of File System]

For example, when information is to be recorded on media (information recording medium) such as a hard disk in a digital video camera, a PC, or other such information processing equipment, a process employing management information of a recorded data file, e.g., a FAT (File Allocation Table) is performed. Examples of the FAT include FAT16 and FAT32. These file systems manage recording position information, recording position chain information, or the like with respect to each data file recorded on media (information recording medium). The details of the FAT16/32 are described in, for example, “Microsoft Extensible Firmware Initiative FAT32 File System Specification”.

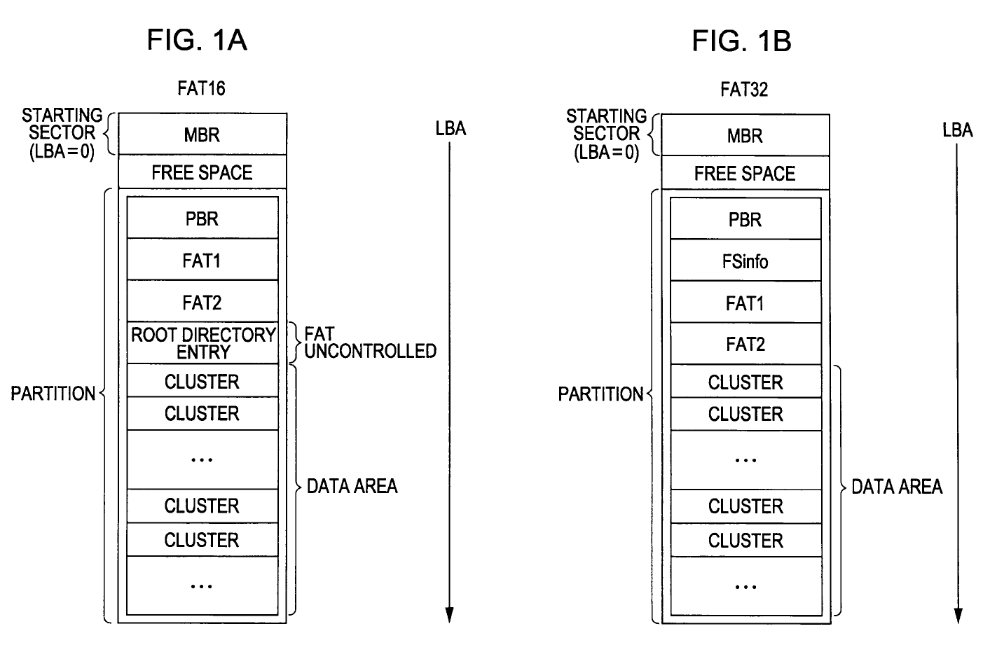

Referring to FIGS. 1A and 1B, a description will be given of the structure of data formatted in FAT16 and FAT32 in a case where one partition is provided on a hard disk. FIG. 1A shows the format of FAT16 and FIG. 1B shows the format of FAT32.

As shown in FIG. 1A, the data structure of FAT16 includes, sequentially from the starting sector (LBA=0), a master boot record (MBR) and a partition boot record (PBR), followed by File Allocation Table 1 (FAT1) and File Allocation Table 2 (FAT2), and further a root directory entry, followed by a plurality of clusters serving as data areas.

As shown in FIG. 1B, the data structure of FAT32 includes, sequentially from the starting sector (LBA=0), a master boot record (MBR), a partition boot record (PBR), and a file system information (FSinfo), followed by File Allocation Table 1 (FAT1) and File Allocation Table 2 (FAT2), which are the followed by a plurality of clusters serving as data areas.

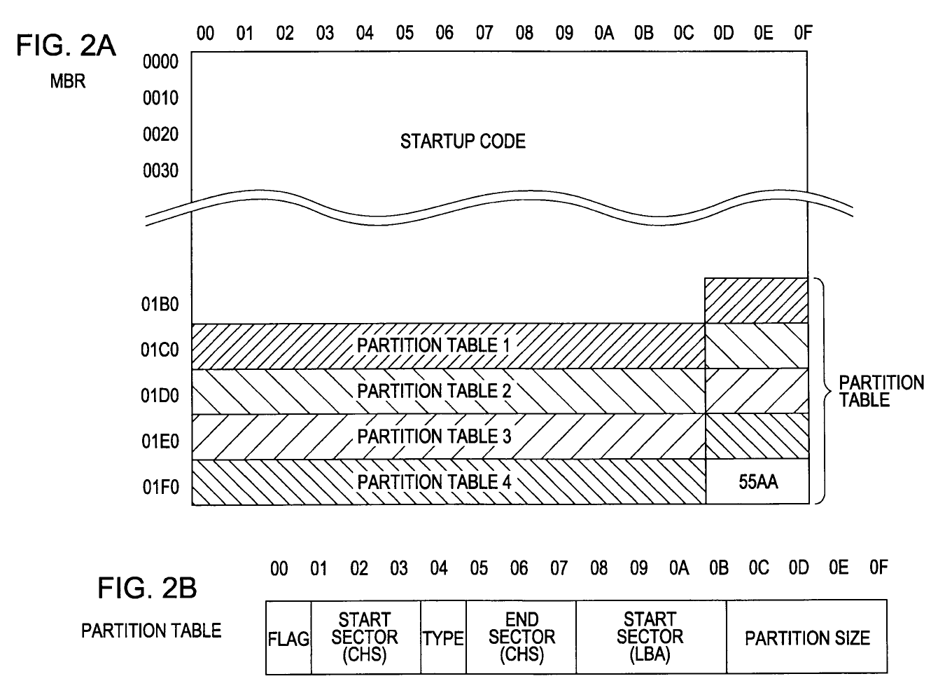

As shown in FIG. 2A, the master boot record (MBR) holds startup information and partition information, that is, partition tables including start addresses and size information of respective partitions. Although only one partition is provided in the data structures of FAT16 and FAT32 shown in FIGS. 1A and 1B, a recording medium such as a hard disk can be segmented into a plurality of partitions for management. In this case, as shown in FIGS. 2A and 2B, partition tables including start addresses and size information of respective partitions of a plurality of partitions are set.

At startup, first, a startup code (program) is read from a startup code area of the MBR. The read startup code of the MBR refers to the partition tables in the partition table area formed immediately after the startup code shown in FIG. 2A, and reads information of the boot sector of a target partition. An OS (Operating System) is started by a code (program) of this boot sector.

A plurality of partition tables (e.g., four tables) can be provided. As described above, each partition table holds information about the position (start address) and size (partition size) of each partition area formed by splitting the recording area of a hard disk, for example. A signature for a partition table is attached in 2 bytes (OE, OF) subsequent to the partition table area.

FIG. 2B shows the data structure of a partition table having a data length of 16 bytes (128 bits). An area of 8 bytes from the 0th byte to the 7th byte is a storage area for information used when specifying an address in a CHS mode, and an area of 8 bytes from the 8th byte to the 15th byte is a storage area for information used when specifying an address in an LBA mode.

In the CHS mode, an address (position) on a recording medium (hard disk) is specified by using three parameters, cylinder, head, and sector as a set. In the LBA mode, for example, numbers (block addresses (logical addresses)) starting with 0 are assigned in a sequential order to respective accessible unit blocks (e.g., units of sectors) on the recording area of a hard disk, so that an address (position) on the recording area of the hard disk is specified by specifying a corresponding number.

As shown in FIG. 2B, the storage area for information used for access in the CHS mode includes the following areas. The 0th byte serves as a storage area for active flag information (hereinafter simply referred to as flag information), 3 bytes from the 1st byte to the 3rd byte serve as a storage area for start sector information used for access in the CHS mode, the 4th byte serves as a storage area for partition type information (hereinafter simply referred to as type information), and 3 bytes from the 5th byte to the 7th byte serve as a storage area for end sector information used for access in the CHS mode.

Also, as shown in FIG. 2B, as for the storage area for information used for access in the LBA mode, 4 bytes from the 8th byte to the 11th byte serve as a storage area for start sector information used in the LBA mode, and 4 bytes from the 12th byte to the 15th byte serve as a storage area for a partition size used in the LBA mode.

It should be noted that in the CHS mode, the physical structure of a hard disk is used as it is and three parameters of cylinder, head, and sector are used for addressing. The CHS mode is thus complex in terms of software processing. In contrast, the LBA mode addresses data using a single parameter called a block address, so an addressing process at the time of access is very simple. For this reason, the LBA mode has become the mainstream mode for addressing on a hard disk. Addressing in the LBA mode is also increasingly supported by many other types of recording medium, such as a variety of memory cards widely used as so-called removable media. Either one of the CHS mode and the LBA mode may be employed in the information processing apparatus according to an embodiment of the present invention.

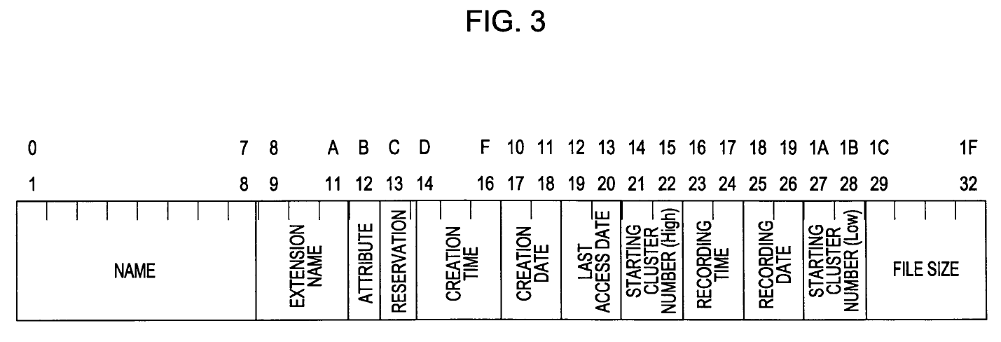

File management information including a file name and date/time of recording is set in each file recorded on the information recording medium. FIG. 3 shows the structure of information stored in a directory provided in each partition, that is, information of a directory entry as file management information formed for each file. The directory entry is file management information that is formed in a directory in accordance with a file formed within a partition, and manages detailed information of the formed file.

As shown in FIG. 3, the directory entry as file management information corresponding to each file includes a name (file name) field, an extension name field, an attribute field, a reservation field, a creation time field, a creation date field, a last access date field, an information field designating a starting cluster number (High), a recording time field, a recording date field, an information field designating a starting cluster number (Low), and a file size field. These fields are used for managing corresponding information, that is, file name, extension name, attribute, creation time, creation date, last access date, starting cluster number (High), recording time, recording date, starting cluster number (Low), and file size. By using the information in the directory entry, (1) the attribute; (2) the position of the starting cluster; (3) the size; (4) the creation date/time; (5) the last access date; and (6) the recording date/time, of a file located by the file name can be managed.

The start cluster number is information used for identifying a storage area on a cluster-by-cluster basis in the data area of a partition with which data recording of a file is started. In other words, the start cluster number indicates at which one of the storage areas, which are obtained by dividing the data area of the partition on a cluster-by-cluster basis, recording of data of the file is started. In the present case, as shown in FIG. 3, the starting cluster number is managed while being divided into upper 2 bytes (high side) and lower 2 bytes (Low side).

As shown in FIGS. 1A and 1B, a cluster, which is included in the data area, is the smallest data management unit in the FAT, and means the smallest recording unit per file as a collection of a plurality of sectors grouped together. One cluster is a collection of n (n=1, 2, 4, . . . 64, 128) sectors (in the case of a hard disk, sector size=512 bytes). Since a sector that is the smallest unit on a hard disk is too small as a file management unit, a unit area called cluster as a collection of a plurality of sectors grouped together is used to facilitate file management. As for the specific size of a cluster, the size of a cluster is, for example, 32 kilobytes in the case of FAT16 and 4 kilobytes in the case of FAT32.

In the data structure of FAT shown in FIGS. 1A and 1B, the master boot record (MBR), which is described above with reference to FIGS. 2A and 2B, is followed by the partition boot record (PBR) including a startup code corresponding to a partition, and then File Allocation Table 1 (FAT1) and File Allocation Table 2 (FAT2).

File Allocation Table 2 (FAT 2) is used as backup data for File Allocation Table 1 (FAT 1). More specifically, File Allocation Table 2 (FAT 2) stores a copy of File Allocation Table 1 (FAT 1).

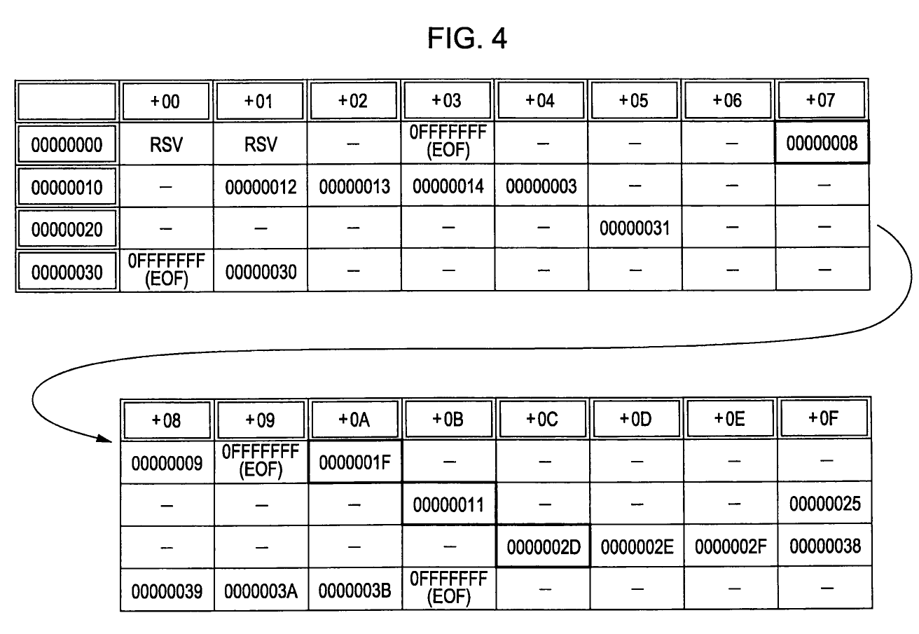

The data structure of a typical file allocation table (FAT) will be described with reference to FIG. 4. The file allocation table (FAT) manages recording position information and recording position chain information with respect to each of data files to be recorded on media (information recording medium).

As described above, data of each data file is recorded onto an information recording medium while being broken into one or more clusters. The file allocation table (FAT) stores chain information of cluster numbers of clusters storing data of each file.

The FAT shown in FIG. 4 is divided into two parts. Double-lined items are indices, and the following cluster numbers are shown as data entry.

[0x00000000] to [0x0000000F]

[0x00000010] to [0x0000001F]

[0x00000020] to [0x0000002F]

[0x00000030] to [0x0000003F]

It should be noted that [0x] is omitted in the table shown in FIG. 4. [0x] mentioned above indicates that the subsequent cluster number represented in eight digits of 0 to F is hexadecimal.

At the position of the cluster number of a cluster storing data of each file, the cluster number of a cluster storing the next one of file data is recorded. A code [0x0FFFFFFF] indicating EOF (End Of File) is recorded at the position of the last cluster number. A starting cluster number is recorded in a directory entry of each file described above with reference to FIG. 3.

For example, starting cluster numbers recorded in directory entries of respective files are assumed to be as follows.

First file: 0x00000007
Second file: 0x0000000A
Third file: 0x0000001B
Fourth file: 0x0000002C

Since the starting cluster number of the first file is [0x00000007], the first data of the first file can be acquired by reading the cluster of the cluster number [0x00000007]. The cluster number of the cluster storing the next data of the first file can be known on the basis of the information recorded at the position of the cluster number [0x00000007] of the FAT shown in FIG. 4. A cluster number [0x00000008] is recorded at the position of the cluster number [0x00000007] of the FAT shown in FIG. 4, and thus it is found that the cluster number of the cluster recording the next data of the first file is [0x00000008], so the next data can be read from the cluster of the cluster number [0x00000008].

Further, the cluster number of a cluster recording the next data of the first file is recorded at the position of the cluster number [0x00000008] of the FAT shown in FIG. 4. A cluster number [0x00000009] is recorded at the position of the cluster number [0x00000008] of the FAT shown in FIG. 4, and thus it is found that the cluster number of the cluster storing the next data of the first file is [0x00000009], so the next data can be read from the cluster of the cluster number [0x00000009]. Further, referring to the information recorded at the position of the cluster number [0x00000009] of the FAT to acquire the cluster number of a cluster storing the next data, a code [0x0FFFFFFF] corresponding to EOF (End Of File) is recorded at that position, so it is found that there is no subsequent data.

As a result, it is found that the data of the first file is stored in the clusters specified by the cluster numbers [0x00000007]→[0x00000008]→[0x00000009]

Likewise, it is found that:

the data of the second file is stored in the clusters specified by the cluster numbers [0x0000000A]→[0x0000001F]→[0x00000025]→[0x00000031]→[0x00000030];

the data of the third file is stored in the clusters specified by the cluster numbers [0x0000001B]→[0x00000011]→[0x00000012]→[0x00000013]→[0x00000014]→[0x00000003]; and

the data of the fourth file is stored in the clusters specified by the cluster numbers [0x0000002C]→[0x0000002D]→[0x0000002E]→[0x0000002F]→[0x00000038]→[0x00000039]→[0x0000003A]→[0x0000003B].

Accordingly, data can be acquired from these clusters.

The FAT shown in FIG. 4 is an example of data corresponding to FAT32. In FAT32, the code corresponding to EOF (End Of File) is [0x0FFFFFFF]. On the other hand, in FAT16, the code corresponding to EOF (End Of File) is [0xFFFF]. By detecting the code corresponding to the EOF, end of file data can be determined.

As described above, each file recorded in an information recording medium has the following three elements:

(a) “directory entry” that holds a file name and creation date/time, a file size, and so on;

(b) “FAT” that holds chain information of clusters; and

(c) “data (substance of file)” recorded in units of clusters. These elements are recorded on the information recording medium such as a hard disk. The clusters in each file are identified on the basis of the “directory entry” and the “FAT”, thus allowing reading of data.

While the three elements are recorded on media such as a hard disk, the three elements are not recorded as a grouped set at a single recording position but are scattered throughout the media.

[2. Example of Data Recording Configuration of Information Recording Medium according to Embodiment of Present Invention]

Next, an example of data recording configuration of an information recording medium according to an embodiment of the present invention will be described. On an information recording medium, there are set partitions that are presented in different ways as seen from an application that executes a data writing or playback process using the information recording medium. Partitions that differ in access permissibility in accordance with the application used, for example, a recording application or a playback application, are set.

Provided that the information processing apparatus is a digital camera, for example, when executing data recording by starting a recording application that executes data recording on the camera, only some partitions (public partitions) set on the information recording medium, that is, only public partitions where data writing is permitted are presented to the application, and the data recording application can perform recording of data only with respect to that public partitions. The existence of other private partitions is not recognized from the data recording application.

Important data whose erroneous deletion by the user should be prevented, such as manuals and programs, sample data, and so on, is recorded in a private partition. This private partition is not presented at the time of execution of the recording application and access to this partition is not permitted. However, when, for example, a playback application for executing playback of a manual is started on a camera, and playback of the manual is executed, access to the private partition becomes possible, and manual data is read to execute a playback process. In this way, whether or not access can be made to each partition is controlled in accordance with the application executed in the application layer.

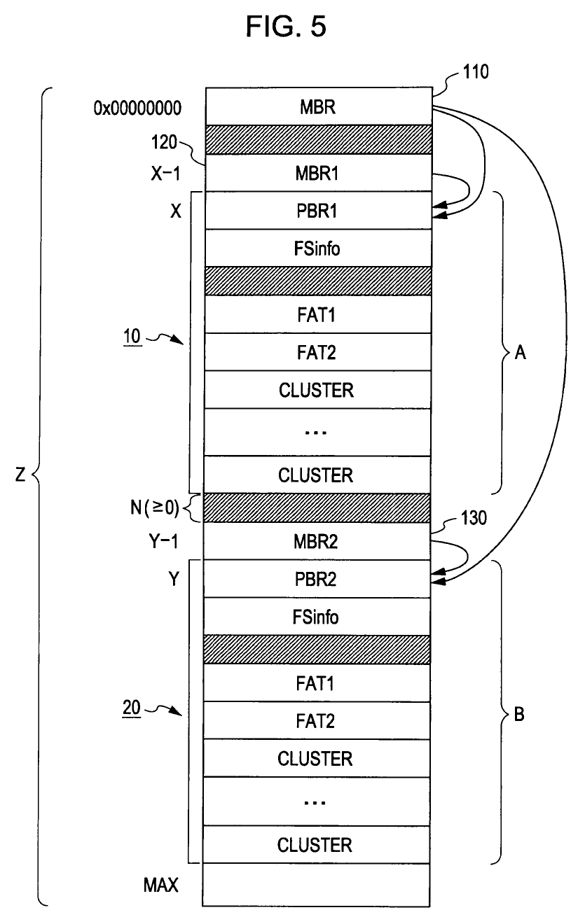

Referring to FIG. 5, a description will be given of the structure of data formatted in FAT 32 in a case where two partitions are provided on a hard disk. The example of format data configuration shown in FIG. 5 includes two partitions, a first partition 10 with a partition size A, and a second partition 20 with a partition size B. The total size is Z.

As in the data formatted in FAT 32 described above with reference to FIG. 1B, a master boot record (MBR) 110 is placed at the logical address (LBA)=0(0x00000000). As described above with reference to FIG. 2A, the master boot record (MBR) 110 holds startup information and partition information, that is, partition tables including start addresses and size information of respective partitions. As shown in FIG. 5, in a case where two partitions, that is, the first partition 10 and the second partition 20 are to be provided, two partition tables corresponding to the two partitions are set in the master boot record (MBR), and the start address and size information of each partition are recorded in each of the tables.

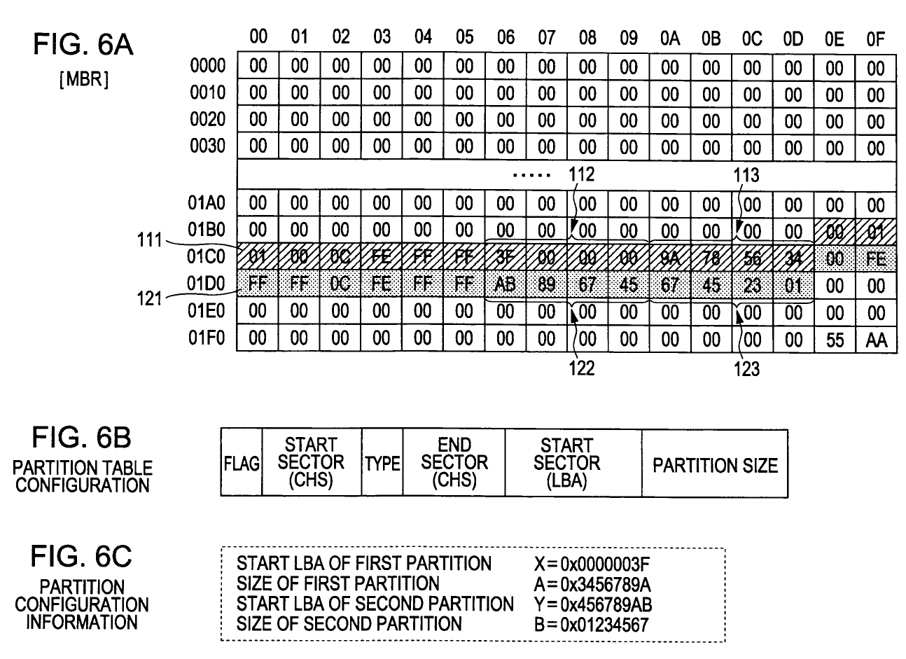

FIGS. 6A to 6B show an example of the data configuration of the master boot record (MBR) 110. FIGS. 6A to 6B show:

(a) Data configuration of the MBR;

(b) Data configuration of partition tables included in the MBR; and

(c) Partition information obtained from the MBR.

FIG. 6A shows the configuration of a master boot record (MBR) corresponding to the formatted data having the two partitions shown in FIG. 5. A partition table 111 corresponding to the first partition 10 shown in FIG. 5, and a partition table 121 corresponding to the second partition 20 are recorded in this master boot record (MBR). Data shown in FIG. 6B is stored in each of the partition tables 111 and 121. That is, as described above with reference to FIG. 2B, 4 bytes from the 8th byte to the 11th byte serve as a storage area for start sector information used in the LBA mode, and 4 bytes from the 12th byte to the 15th byte serve as a storage area for a partition size used in the LBA mode.

That is, in the partition table 111 corresponding to the first partition of the MBR shown in FIG. 6A, a first-partition-start-sector (LBA) recording area 112, and a partition-size recording area 113 are set. In the partition table 121 corresponding to the second partition, a second-partition-start-sector (LBA) recording area 122, and a partition-size recording area 123 are set. Start sector (LBA) information and size information corresponding to each partition are recorded in each of the partition table 111 and partition table 112.

As shown in FIG. 6C, the following pieces of information can be obtained from these pieces of recorded information:

Start LBA of the first partition: X=0x0000003F

Size of the first partition: A=0x3456789A

Start LBA of the second partition: Y=0x456789AB

Size of the second partition: B=0x01234567

As described above, the master boot record (MBR) set at the logical address (LBA)=0(0x00000000) in the data configuration shown in FIG. 5 holds the start LBA (In the case of FAT, PBR is located; herein referred to as PBR1, PBR2) as the start address of each partition. The start addresses of two partitions can be obtained by referring to the MBR.

PBR1 and PBR2 each set at the position of the start LBA as the start address of each partition are partition boot records (PBRs) containing startup codes corresponding to the first partition 10 and the second partition 20, respectively.

That is,

Start LBA of the first partition 10: PBR1 corresponding to the first partition 10 is set at the position X, and Start LBA of the second partition 20: PBR2 corresponding to the second partition 20 is set at the position Y.

In this way, PBRs corresponding to the first partition 10 and the second partition 20 are individually set. Further, MBR1, 120 and MBR2, 130 dedicated to partitions corresponding to the first partition 10 and the second partition 20 are placed immediately before PBR1 and PBR2, respectively.

That is,

Start LBA of the first partition 10: MBR1 corresponding to the first partition 10 is set at the position (LBA=X−1) immediately before X, and

Start LBA of the second partition 20: MBR2 corresponding to the second partition 20 is set at the position (LBA=Y−1) immediately before Y.

A gap of one sector or more is to be provided between the first partition 10 and the second partition 20.

MBR1, 120 is a partition-specific master boot record (MBR) dedicated to the first partition 10, and MBR2, 130 is a partition-specific master boot record (MBR) dedicated to the second partition 20.

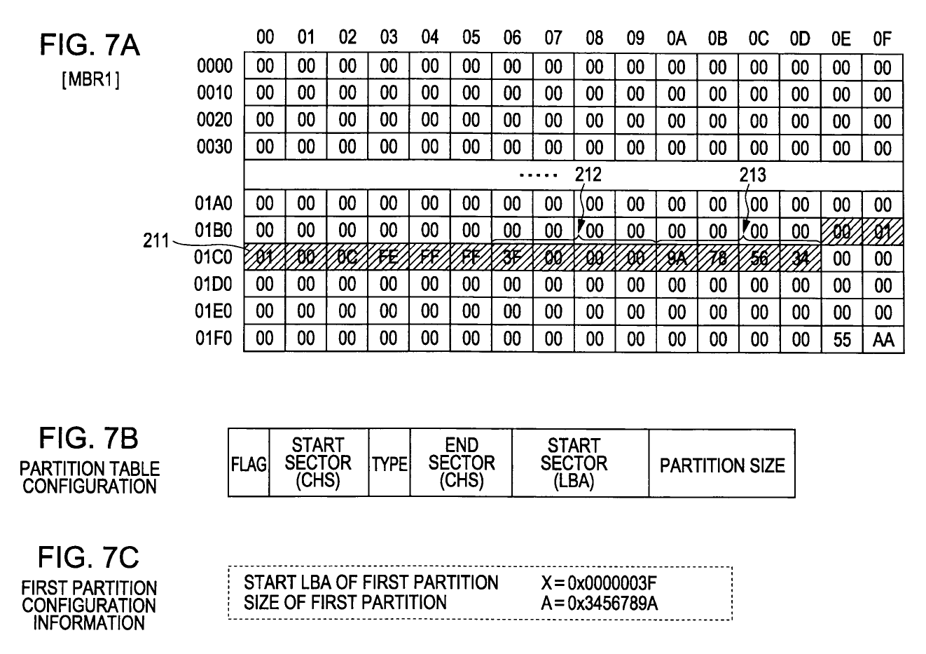

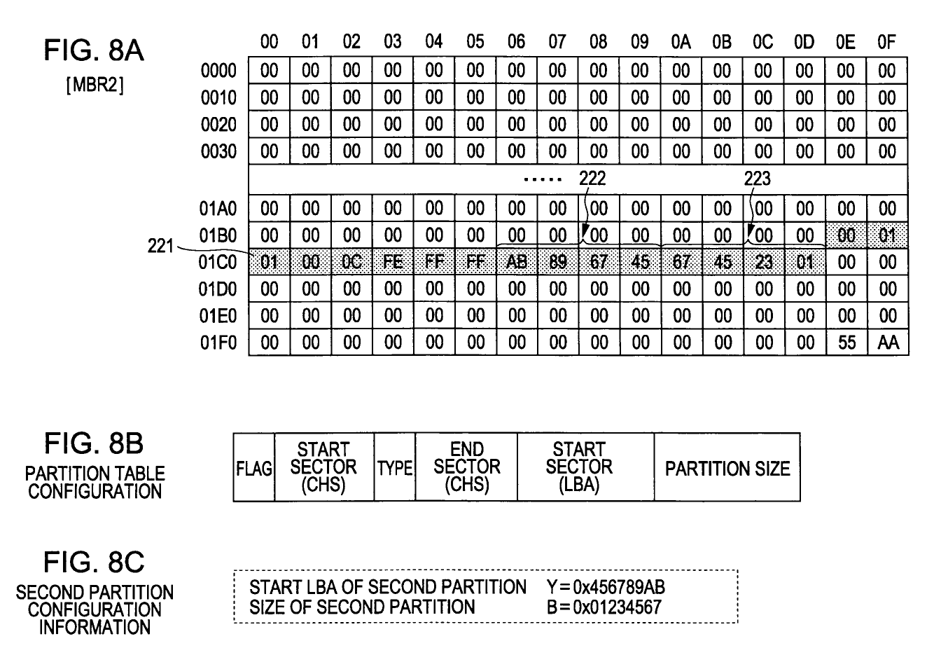

FIGS. 7A to 7B show an example of the data configuration of MBR1, 120 that is a partition-specific master boot record (MBR) dedicated to the first partition 10, and FIGS. 8A to 8C show an example of the data configuration of MBR2, 130 that is a partition-specific master boot record (MBR) dedicated to the second partition 20. Like FIGS. 6A to 6C, FIG. 7A to 7C show:

(a) Data configuration of MBR1;

(b) Data configuration of a partition table included in MBR1; and

(c) Partition information obtained from MBR1.

FIG. 7A shows the configuration of the partition-specific master boot record 1 (MBR1), 120 corresponding to the first partition 10 shown in FIG. 5. Only a partition table 211 corresponding to the first partition 10 shown in FIG. 5 is recorded in the partition-specific master boot record 1 (MBR1), 120. That is, a partition table corresponding to the second partition 20 shown in FIG. 5 is not recorded.

The partition table 211 is a table that records information corresponding to the first partition 10 shown in FIG. 5. That is, the partition table 211 stores each data shown in FIG. 7B. That is, 4 bytes from the 8th byte to the 11th byte serve as a storage area for start sector information used in the LBA mode, and 4 bytes from the 12th byte to the 15th byte serve as a storage area for a partition size used in the LBA mode.

That is, in the partition table 211 corresponding to the first partition which is recorded in the partition-specific master boot record 1 (MBR1), 120 shown in FIG. 7A, a first-partition-start-sector (LBA) recording area 212, and a partition-size recording area 213 are set.

As shown in FIG. 7C, the following pieces of information can be obtained from these pieces of recorded information:

Start LBA of the first partition: X=0x0000003F

Size of the first partition: A=0x3456789A

As described above, the master boot record 1 (MBR1), 120 corresponding to the first partition, which is set at the logical address (LBA)=X−1 in the data configuration shown in FIG. 5, holds the start LBA as the start address and size information of the first partition. By referring to this MBR1, the start address and size of only the first partition 10 can be obtained, thus enabling access to only the first partition 10. It should be noted, however, that access cannot be made to the second partition because no information is obtained with respect to the second partition.

Next, FIG. 8 shows an example of the data configuration of MBR2, 130 that is a master boot record (MBR) dedicated to the second partition 20. Like FIGS. 6A to 6C and 7A to 7C, FIGS. 8A to BC show:

(a) Data configuration of MBR2;

(b) Data configuration of a partition table included in MBR2; and

(c) Partition information obtained from MBR2.

FIG. 8A shows the configuration of the partition-specific master boot record 2 (MBR2), 130 corresponding to the second partition 20 shown in FIG. 5. Only a partition table 221 corresponding to the second partition 20 shown in FIG. 5 is recorded in the partition-specific master boot record 2 (MBR2), 130. That is, a partition table corresponding to the first partition 10 shown in FIG. 5 is not recorded.

The partition table 221 is a table that records information corresponding to the second partition 20 shown in FIG. 5. That is, each data shown in FIG. 8B is stored. That is, 4 bytes from the 8th byte to the 11th byte serve as a storage area for start sector information used in the LBA mode, and 4 bytes from the 12th byte to the 15th byte serve as a storage area for a partition size used in the LBA mode.

That is, in the partition table 221 corresponding to the second partition which is recorded in the partition-specific master boot record 2 (MBR2), 130 shown in FIG. 8A, a second-partition-start-sector (LBA) recording area 222, and a partition-size recording area 223 are set.

As shown in FIG. 8C, the following pieces of information can be obtained from these pieces of recorded information:

Start LBA of the second partition: X=0x456789AB Size of the second partition: B=0x01234567

As described above, the master boot record 2 (MBR2), 130 corresponding to the second partition, which is set at the logical address (LBA)=Y−1 in the data configuration shown in FIG. 5, holds the start LBA as the start address and size information of the second partition. By referring to this MBR2, the start address and size of only the second partition 20 can be obtained, thus enabling access to only the second partition 20. It should be noted, however, that access cannot be made to the first partition because no information is obtained with respect to the first partition.

As described above, the formatted data shown in FIG. 5 includes the following master boot records (MBRs):

a MBR storing partition tables corresponding to all of the partitions of the storage area; and

partition-specific MBRs each storing only a partition table specific to each individual partition.

By adopting such arrangement of information, it is possible to realize three connection modes (manners of presentation to a host application (software)) as described below while maintaining connection compatibility with existing equipment:

(a) Two partitions (the first partition 10 and the second partition 20) are visible from MBR;

(b) One partition (only the first partition) is visible from MBR1; and

(c) One partition (only the second partition) is visible from MBR2.

That is, selective access can be made to MBR, MBR1, and MBR2 in accordance with the kind of an application as host software that executes access to an information recording medium having the format configuration shown in FIG. 5.

For instance, assuming that the information processing apparatus is a digital camera, with respect to a data recording application that can be used by the user, the data recording application is allowed to read only MBR1 so that recording/playback of data is executed by using only the first partition. Further, with respect to a data playback application that can be used by the user, the data playback application is allowed to read MBR, or selectively read MBR1 and MBR2 so that data recorded in the first partition and the second partition can be read for playback.

For example, by recording data that should not be deleted, such as manuals, programs, and sample data, in the second partition in advance, the data recorded in the second partition can be accessed only by the playback application, thereby making it possible to prevent data from being deleted due to erroneous writing of additional data or the like through processing of the recording application.

When making each partition from MBR1 or MBR2 onwards, instead of the whole media (from MBR onwards), public (accessible) in a restricted manner, with respect to an inquiry for recording medium information from the application, an offset process is performed whereby the LBA where MBR1 (or MBR2) is actually placed is virtually set as LBA=0, and the partition size is calculated as the size of the whole media. These pieces of information are then presented to the application.

That is, with respect to an inquiry for recording medium information from the application, an access control section sets media including solely access-permitted partitions as virtual media, calculates the start sector (LBA) information and the size information, and presents these pieces of information to the application. This setting enables control as to whether a partition should be made public or private while maintaining connection compatibility with existing equipment. It should be noted that this configuration is applicable to removable media in the same manner as to media built in the main unit.

As the mode of access to an information recording medium by an application, the following three access modes are selectively used in accordance with the kind of the application.

[Access Mode A]

A setting where the entire media is accessible.

This is an access mode in which, regardless of whether the media used is built in the main unit of equipment or is removable, the MBR recorded at LBA=0 is read by the same access procedure as in the related art, and access can be made to the first partition and the second partition on the basis of the contents of the MBR.

[Access Mode B]

A setting where only the first partition 10 shown in FIG. 5 is accessible.

This mode assumes media that is built in the main unit of equipment. By software control, the following media size and start LBA as the start address are made public to the application as information corresponding to the first partition:

Media size=A; and

Start LBA=X−1.

This setting allows the second partition to be hidden.

[Access Mode C]

A setting where only the second partition 20 shown in FIG. 5 is accessible.

This mode assumes media that is built in the main unit of equipment. By software control, the following media size and start LBA as the start address are made public to the application as information corresponding to the second partition:

Media size=B; and

Start LBA Y−1.

This setting allows the first partition to be hidden.

It should be noted that a so-called formatting process, whereby an information recording medium such as a hard disk is formatted into the format as shown in FIG. 5, for example, can be executed by an information processing process such as a PC, for example. That is, the data processing section of an information processing apparatus such as a PC executes a formatting program corresponding to the format shown in FIG. 5 to thereby execute a formatting process in which a plurality of partitions serving as a plurality of segmented data recording areas are set, and a partition-specific master boot record (MBR) dedicated to each partition is recorded in each of the partitions. With respect to each partition-specific master boot record (MBR), a process of recording a partition table for only a corresponding partition, in which the starting sector address and size information of the corresponding partition is recorded, is executed.

[3. Example of Configuration and Processing of Information Processing Apparatus]

Next, an example of the configuration and processing of the information processing apparatus according to an embodiment of the present invention will be described. The information processing apparatus according to an embodiment of the present invention is an apparatus that performs recording of data onto an information recording medium, or playback of data from the information recording medium. Examples of the information processing apparatus include a digital video camera and a PC.

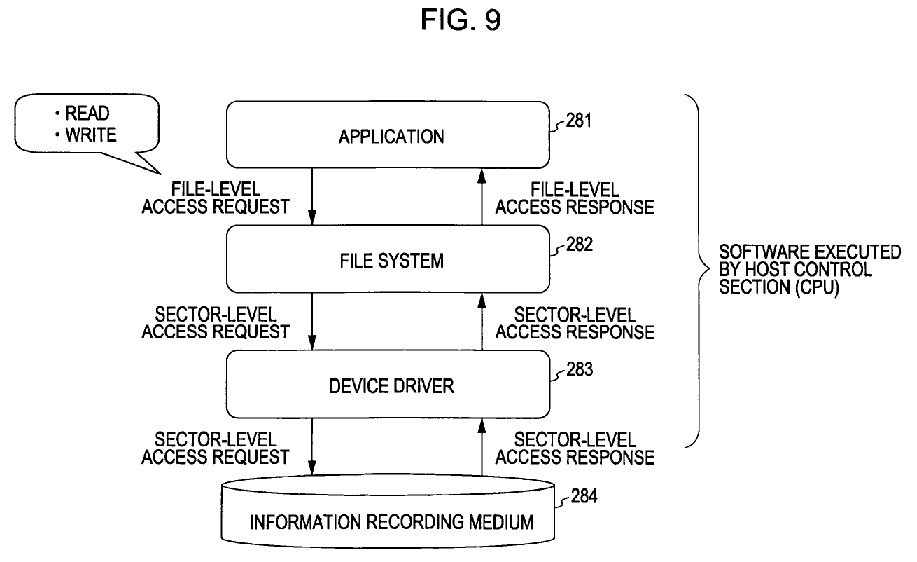

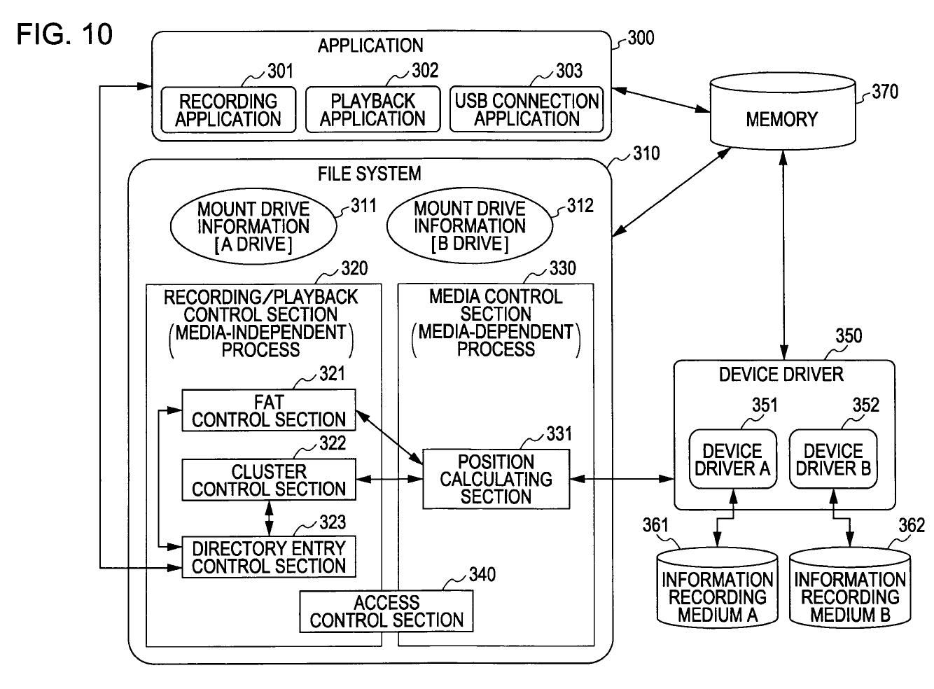

The configuration of the information processing apparatus will be described with reference to FIGS. 9 and 10. FIG. 9 shows, by process layer, the configuration of an information processing apparatus that executes data recording or data reading by accessing an information recording medium 284 such as a hard disk. As shown in FIG. 9, an application program 281 exists at the uppermost layer. When recording data onto the information recording medium 284 such as a hard disk, or when reading and using data recorded on the recording medium, the application program 281 serves as a channel of contact with the user for accepting a processing request from the user, or providing a user interface. A file system (file management program) 282 for managing a file on the information recording medium 284 and a device driver 283 for controlling the information recording medium 204 in accordance with information from the file system are present under the application program 281.

When data is to be recorded on the information recording medium 284 or when data is to be played back from the information recording medium 284, for example, a request is transmitted to the file system 282 and the device driver 283 via the application program 281, and writing or playback of data is executed by the functions of the file system 282 and the device driver 283. As in the related art, the process is performed by a combination of the file system, device driver, and recording medium (hard disk) interacting with each other.

In a case where a plurality of different files are employed as a continuously recorded file when performing data recording, recording of a special code with respect to the file allocation table (FAT) employed by the file system is performed. Also, in a case where a plurality of different files are used as a continuously recorded file when executing data playback, file switching is executed on the condition that the special code is detected from the FAT.

FIG. 10 shows the file system in the system configuration shown in FIG. 9 in more detail. Like FIG. 9, FIG. 10 is a diagram showing the system configuration of an information processing apparatus that performs recording of data onto an information recording medium, and acquisition and playback of data from the information recording medium. That is, FIG. 10 shows the system configuration of an information processing apparatus that executes a process of recording data onto information recording mediums 361 and 362 such as a hard disk or a flash memory, or reading and using data recorded on the recording medium.

As in FIG. 9, in FIG. 10, a file system (file management program) 310 for managing a file on each of the information recording mediums 361 and 362 and a device driver 350 for controlling the information recording mediums 361 and 362 on the basis of information from the file system 310 are present under the application 300. In FIG. 10, two information recording mediums 361 and 362 are shown. These information recording mediums are, for example, recording mediums such as a hard disk having the format described above with reference to FIG. 5, and a flash memory. The device driver 350 has device drivers 351 and 352 respectively corresponding to the information recording mediums 361 and 362 as recording devices.

The application 300, the file system 310, and the device driver 350 access and use a memory 370, which serves as a storage for programs and parameters required for processes in respective sections and as a work area in data processing.

The application 300 includes applications according to processes, such as a recording application 301 that executes a data recording process with respect to the information recording mediums 361 and 362, a playback application 302 that executes a playback process of data recorded on the information recording mediums 361 and 362, and a USB connection application that executes processing by connected equipment.

The user executes various processes by selecting these applications. It should be noted that in accordance with these applications, the storing section segmented into a plurality of partitions described above with reference to FIG. 5, for example, a partition on the information recording medium A361 shown in FIG. 10 to which access can be made, is determined. These processes for each application will be described later. It should be noted that in the following description, it is assumed that of the two information recording mediums A and B shown in FIG. 10, the information recording medium A361 is a hard disk having the format configuration shown in FIG. 5, and the information recording medium B362 is a storage medium other than a hard disk, such as a flash memory or a DVD. According to the present invention, it suffices that at least one storage medium be a medium having the format configuration shown in FIG. 5.

The file system 310 holds mount drive information 311 and 312 corresponding to each storage medium, including the type and format information of a recording medium, and executes control of data recording/playback employing an information recording medium such as a hard disk, in accordance with the mount drive information 311 and 312. The file system 310 includes a recording/playback control section 320 that executes control of data recording/playback, and a media control section 330 that executes media control. The process executed by the recording/playback control section 320 is a media-independent process that is common across media types. The process executed by the media control section 330 is a media-dependent process.

The recording/playback control section 320 includes a FAT control section 321, a cluster control section 322, and a directory entry control section 323. The FAT control section 321 executes a process of recording and referring to the file application table (FAT). The cluster control section 322 executes a process of determining a cluster as data recording position information, and determining a playback position based on a cluster number. The directory entry control section 323 generates or refers to a directory entry (see FIG. 3) storing information corresponding to a file. The directory entry control section 323 acquires a directory entry corresponding to a specific file on the basis of information specifying a storage section or file from the application 300. For example, in the case of file playback, the directory entry control section 323 acquires the starting cluster number from the directory entry, and supplies the starting cluster number to the cluster control section 322.

The media control section 330 includes a position calculating section 331. The media control section 330 controls the device driver 350 on the basis of cluster information determined by the cluster control section 322 or cluster chain information of a FAT, determines the position on a disk where data recording or data playback is executed on the basis of a cluster number, and executes data recording to or data playback from the corresponding disk position via the device driver 350 in accordance with the determined position information.

An access control section 340 performs control of access to the storage section according to an application described above with reference to FIGS. 5 to 8C. With respect to both the media control section 320 that executes a media-independent process that is common across media types, and the media control section 330 that executes a media-dependent process, the access control section 340 executes access control according to the respective processes. While the access control section 340 is configured within the file system 310 in the configuration shown in FIG. 10, the access control section 340 may be configured within the device driver 350, or may be configured as an independent control section that is set intermediate between the file system 310 and the device driver 350.

Hereinbelow, assuming that the information recording medium A361 is a formatted hard disk having the two partitions shown in FIG. 5, and the information recording medium B362 is a flash memory such as a memory stick (registered trademark), a description will be given of the details of access control with respect to the information recording medium A361 which is executed in the information processing apparatus.

The access control section 340 performs access control according to the kind of an application executed in the application 300, that is, the following applications to be executed:

the recording application 301;

the playback application 302; and

the USB connection application 303.

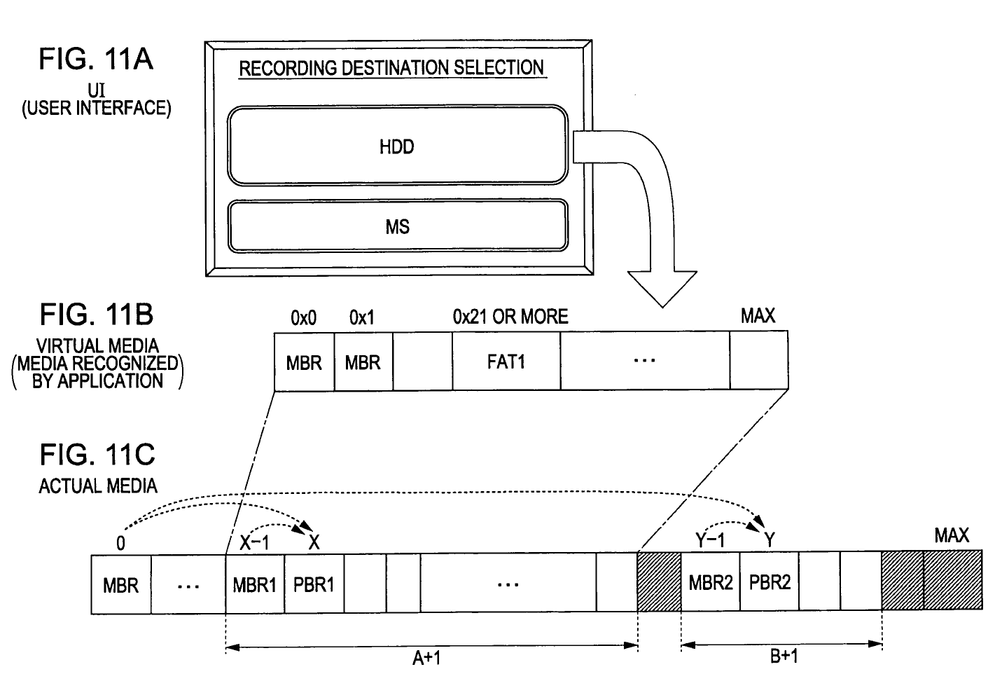

A specific example of access control will be described with reference to FIGS. 11A to 11C onwards.

FIGS. 11A to 11C are diagrams illustrating an example of processing in a case where the user selects the recording application 301 as the application to be executed. FIG. 11A shows a user interface (UI) displayed on the display of the information processing apparatus when the recording application 301 is selected as the application to be executed. As the recording destination, a selection screen for selecting between two information recording mediums, that is, the following recording mediums shown in FIG. 10 are presented as a UI:

the information recording medium A (HDD) 361; and

the information recording medium B (MS: flash memory) 362.

In a case where the information recording medium A (HDD) 361 is selected as the recording destination upon execution of the recording application 301, by the control of the access control section 340, the configuration of the hard disk as recognized by the application becomes that of a virtual HDD shown in FIG. 11B. That is, only the first partition area as a part of the data area of the actual hard disk shown in FIG. 11C is set as the HDD that can be recognized by the recording application 301.

When executing the recording application 301 to perform recording of data, MBR1: the master boot record corresponding to the first partition described above with reference to FIGS. 7A to 7C is set as a readable MBR, the information related to the first partition recorded in the partition table set in MBR1 described above with reference to FIGS. 7A to 7C, that is, the following pieces of information:

Start LBA of the first partition: X=0x0000003F

Size of the first partition: A=0x3456789A,

are read by the recording application 301, and a data recording process is performed with the first partition as the data recording area.

The recording application 301 acquires X: the start LBA of the first partition from the master boot record (MBR) (in actuality, MBR1) set in the virtual HDD shown in FIG. 11B, acquires the position of PBR (partition boot record) (in actuality, PBR1) from the X as the start address, and executes a partition-specific startup code included in PBR1, thereby performing a data recording process by accessing only the area of the first partition.

Specifically, as a recording device identifier that can be specified by the recording application 301, a device identifier for HDD [dev/hdd1] is set. The access control section performs a process of setting the virtual HDD as shown in FIG. 11B by means of this identifier [dev/hdd1] specified from the recording application 301, and presenting the virtual HDD to the recording application 301. The specific sequence of this process will be described later with reference to a flow chart.

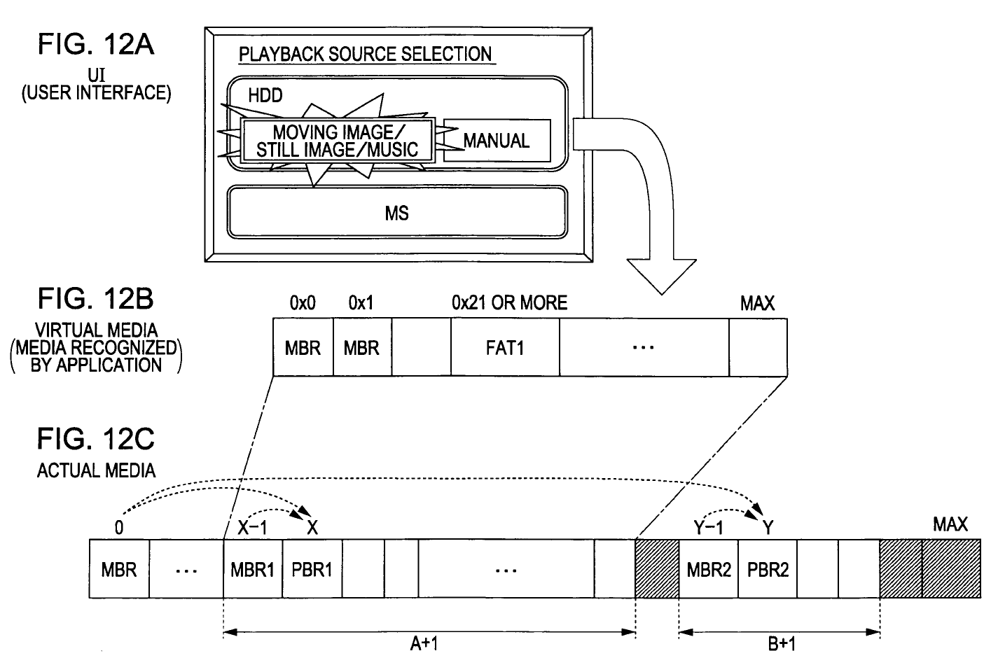

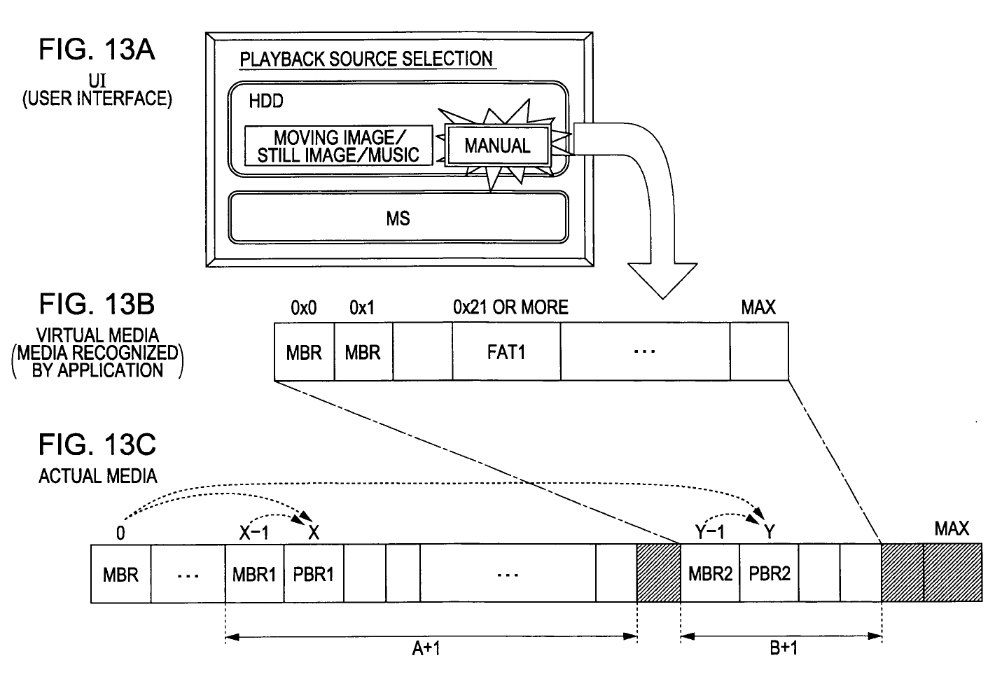

Next, referring to FIGS. 12A to 13C, a description will be given of an example of processing in a case where the user selects the playback application 302 as the application to be executed. FIG. 12A shows a user interface (UI) displayed on the display of the information processing apparatus when the playback application 302 is selected as the application to be executed. As the playback source media, a selection screen for selecting between two information recording mediums, that is, the following recording mediums shown in FIG. 10 are presented as a UI:

the information recording medium A (HDD) 361; and

the information recording medium B (MS: flash memory) 362.

Further, as the playback category corresponding to the information recording medium A (HDD) 361, a selection screen for selecting between the following two categories is presented:

[Moving image/still image/music]

[Manual]

In this example, it is assumed that:

the first partition is a partition to which user data can be recorded, and is set as an area to/from which [Moving image/still image/music] as user data can be recorded/played back; and

the second partition does not permit recording of user data, and is set as an area where previously recorded data such as manuals is recorded. While the data recorded in the second partition is described as [Manual] in this example, the second partition can be used as an area for recording various kinds of data other than manuals, such as programs or sample image data.

FIG. 12A shows an example of UI in a case where the playback application 302 is executed, and [Moving image/still image/music] is selected as the playback source. In the case where playback of [Moving image/still image/music] serving as user data is selected in this way, the configuration of the hard disk as recognized by the application becomes that of a virtual HDD shown in FIG. 12B. That is, only the first partition area as a part of the data area of the actual hard disk shown in FIG. 12C is set as the HDD that can be recognized by the playback application 302.

When executing the playback application 302 to perform data playback of [Moving image/still image/music], MBR1 corresponding to the first partition described above with reference to FIGS. 7A to 7C is set as a readable MBR, the information related to the first partition recorded in the partition table set in MBR1 described above with reference to FIGS. 7A to 7C, that is, the following pieces of information:

Start LBA of the first partition: X=0x0000003F

Size of the first partition: A=0x3456789A,

are read by the playback application 302, and a data playback process is performed with the first partition as the data playback area.

The playback application 302 acquires X: the start LBA of the first partition from the master boot record (MBR) (in actuality, MBR1) set in the virtual HDD shown in FIG. 12B, acquires the position of PBR (partition boot record) (in actuality, PBR1) from the X as the start address, and executes a partition-specific startup code included in PBR1, thereby performing a data playback process by accessing only the area of the first partition. Moving images, still images, music, and the like as user data are recorded in the first partition, and playback of these pieces of data is executed.

Specifically, in a case where the playback source selected by the playback application 302 is [Moving image/still image/music], a device identifier [dev/hdd1] that can be specified is set. The access control section sets the virtual HDD as shown in FIG. 12B by means of this identifier [dev/hdd1] specified by the playback application 302, and provides the virtual HDD to the playback application 302. The specific sequence of this process will be described later with reference to a flow chart.

FIG. 13A shows an example of UI in a case where the playback application 302 is executed, and further [Manual] is selected as the playback source. In a case where playback of [Manual] is selected in this way, by the control of the access control section 340, the configuration of the hard disk as recognized by the application becomes that of a virtual HDD shown in FIG. 13B. That is, only the second partition area as a part of the data area of the actual hard disk shown in FIG. 13C is set as the HDD that can be recognized by the playback application 302.

When executing the playback application 302 to perform data playback of [Manual], MBR2 corresponding to the second partition described above with reference to FIGS. 8A to 8C is set as a readable MBR, the information related to the second partition recorded in the partition table set in MBR2 described above with reference to FIGS. 8A to 8C, that is, the following pieces of information:

Start LBA of the second partition: Y=0x456789AB

Size of the second partition: B=0x01234567,

are read by the playback application 302, and a data playback process is performed with the second partition as the data playback area.

The playback application 302 acquires Y: the start LBA of the second partition from the master boot record (MBR) (in actuality, MBR2) set in the virtual HDD shown in FIG. 13B, acquires the position of PBR (partition boot record) (in actuality, PBR2) from the Y as the start address, and executes a partition-specific startup code included in PBR2, thereby performing a data playback process by accessing only the area of the second partition. Manuals are recorded in the second partition, and playback of the manuals is executed.

Specifically, in a case where the playback source selected by the playback application 302 is [Manual], a device identifier [dev/hdd2] that can be specified is set. The access control section sets the virtual HDD as shown in FIG. 13B by means of this identifier [dev/hdd2] specified by the playback application 302, and provides the virtual HDD to the playback application 302. The specific sequence of this process will be described later with reference to a flow chart.

When it is desired to execute a recording/playback process by accessing the information recording medium (HDD) 361 of this information processing apparatus (e.g. a digital camera) from USB-connected external equipment (e.g. a PC), the USB connection application 303 is executed.

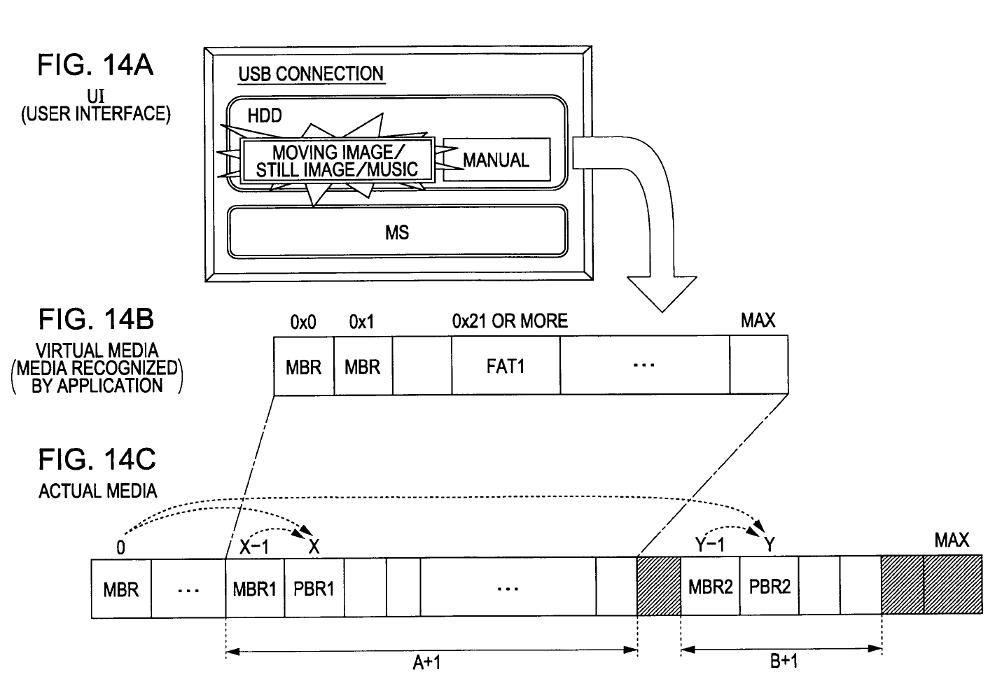

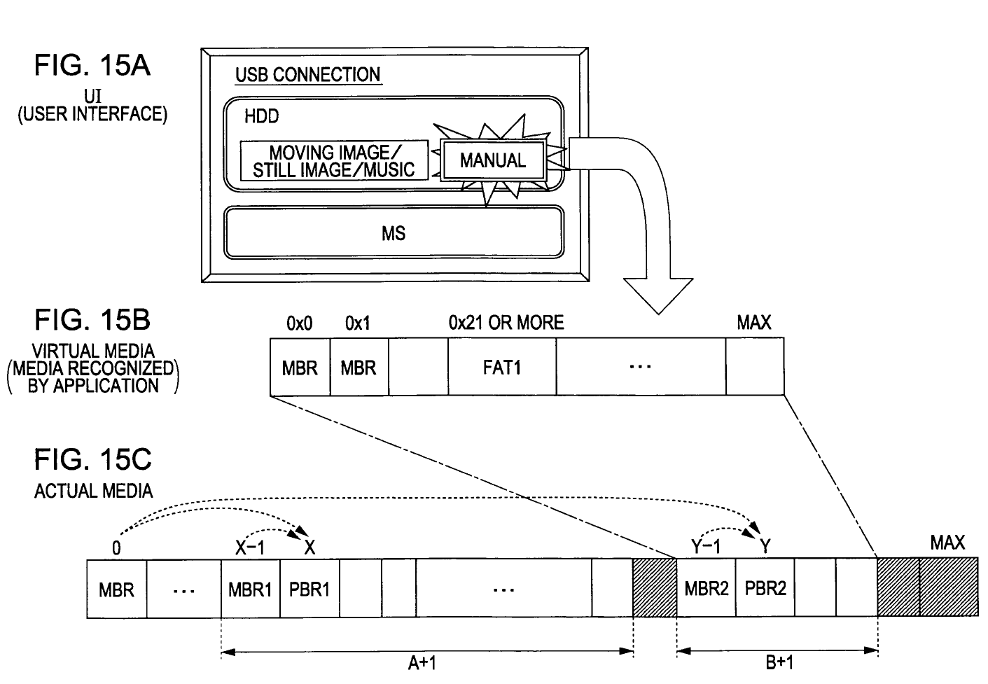

A data recording/playback process in a case where the USB connection application 303 is executed will be described with reference to FIGS. 14A to 15C. The process at the time of executing the USB connection application 303 is basically the same as that at the time of executing the playback application described above with reference to FIGS. 12A to 13C in that both Partition 1 and Partition 2 are accessible. The difference is that while a data recording process cannot be executed at the time of executing the playback application, data can be recorded to both Partition 1 and Partition 2 at the time of executing the USB connection application 303. The USB connection application 303 can be used when, for example, updating manuals recorded in Partition 2, adding new protected data, or the like. Further, the USB connection application 303 can be also used for a process of recording data such as manuals at the time of product manufacture.

FIG. 14A shows a user interface (UI) displayed on the display of the information processing apparatus when the USB connection application 303 is selected as the application to be executed. As the recording or playback processing media, a selection screen for selecting between two information recording mediums, that is, the following recording mediums shown in FIG. 10 are presented as a UI:

the information recording medium A (HDD) 361; and

the information recording medium B (MS: flash memory) 362.

Further, as the category corresponding to the information recording medium A (HDD) 361, a selection screen for selecting between the following two categories is presented:

[Moving image/still image/music]

[Manual].

As described above, in this example, the first partition is a partition to which user data can be recorded, and is set as an area to/from which [Moving image/still image/music] as user data can be recorded/played back, and the second partition does not permit recording of user data, and is set as an area where previously recorded data such as manuals is recorded.

FIG. 14A shows an example of UI in a case where the USB connection application 303 is executed, and [Moving image/still image/music] is selected as the recording or playback source. In the case where recording or playback of [Moving image/still image/music] serving as user data is selected in this way, the configuration of the hard disk as recognized by the application becomes that of a virtual HDD shown in FIG. 14B. That is, only the first partition area as a part of the data area of the actual hard disk shown in FIG. 14C is set as the HDD that can be recognized by the USB connection application 303.

When executing the USB connection application 303 to perform data recording or playback of [Moving image/still image/music], MBR1 corresponding to the first partition described above with reference to FIGS. 7A to 7C is set as a readable MBR, the information related to the first partition recorded in the partition table set in MBR1 described above with reference to FIGS. 7A to 7C, that is, the following pieces of information:

Start LBA of the first partition: X=0x0000003F

Size of the first partition: A=0x3456789A,

are read by the USB connection application 303, and a data recording or playback process is performed with the first partition as the data recording/playback area.

The playback application 303 acquires X: the start LBA of the first partition from the master boot record (MBR) (in actuality, MBR1) set in the virtual HDD shown in FIG. 14B, acquires the position of PBR (partition boot record) (in actuality, PBR1) from the X as the start address, and executes a partition-specific startup code included in PBR1, thereby performing a data recording or playback process by accessing only the area of the first partition. Moving images, still images, music, and the like as user data are recorded in the first partition, and recording/playback of these pieces of data is executed.

Specifically, in a case where the playback source selected by the USB connection application 303 is [Moving image/still image/music], a device identifier [dev/hdd1]that can be specified is set. The access control section sets the virtual HDD as shown in FIG. 14B by means of this identifier [dev/hdd1] specified by the USB connection application 303, and provides the virtual HDD to the USB connection application 303. The specific sequence of this process will be described later with reference to a flow chart.

FIG. 15A shows an example of UI in a case where the USB connection application is executed, and further [Manual] is selected as the recording or playback source. In a case where recording or playback of [Manual] is selected in this way, by the control of the access control section 340, the configuration of the hard disk as recognized by the application becomes that of a virtual HDD shown in FIG. 15B. That is, only the second partition area as a part of the data area of the actual hard disk shown in FIG. 15C is set as the HDD that can be recognized by the USB connection application 303.

When executing the USB connection application 303 to perform data playback of [Manual], MBR2 corresponding to the second partition described above with reference to FIGS. 8A to 8C is set as a readable MBR, the information related to the second partition recorded in the partition table set in MBR2 described above with reference to FIGS. 8A to 8C, that is, the following pieces of information:

Start LBA of the second partition: Y=0x456789AB

Size of the second partition: B=0x01234567,

are read by the USB connection application 303, and a process with the second partition set as the data recording or playback area is performed. It should be noted that the process based on this setting can be also used when performing a process of recording manuals at the time of manufacture, for example.

The USB connection application 303 acquires Y: the start LBA of the second partition from the master boot record (MBR) (in actuality, MBR2) set in the virtual HDD shown in FIG. 15B, acquires the position of PBR (partition boot record) (in actuality, PBR2) from the Y as the start address, and executes a partition-specific startup code included in PBR2, thereby performing a data recording or playback process by accessing only the area of the second partition.

Specifically, in a case where the playback source selected by the USB connection application 303 is [Manual], a device identifier [dev/hdd2] that can be specified is set. The access control section sets the virtual HDD as shown in FIG. 15B by means of this identifier [dev/hdd2] specified by the USB connection application 303, and provides the virtual HDD to the USB connection application 303. The specific sequence of this process will be described later with reference to a flow chart.

[4. Details of Sequence of Process executed by Information Processing Apparatus]

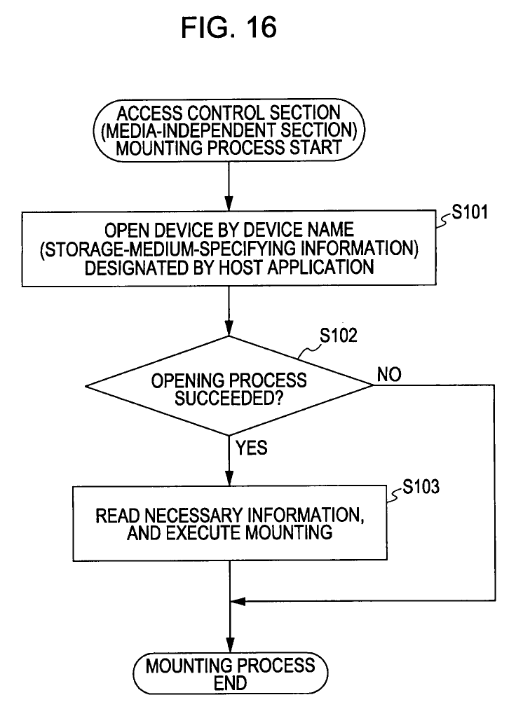

Next, details of a process sequence executed by the information processing apparatus according to an embodiment of the present invention will be described with reference to FIG. 16 onwards.

First, referring to FIGS. 16 to 18, a mounting process sequence for an information recording medium (media) will be described. A media mounting process is executed as pre-processing for data recording or playback, and is executed as a process of recognizing an information recording medium (media), and acquiring information necessary for accessing the information recording medium (media). For example, the media mounting process is executed on the basis of an input of media-specifying information from the application to the file system.

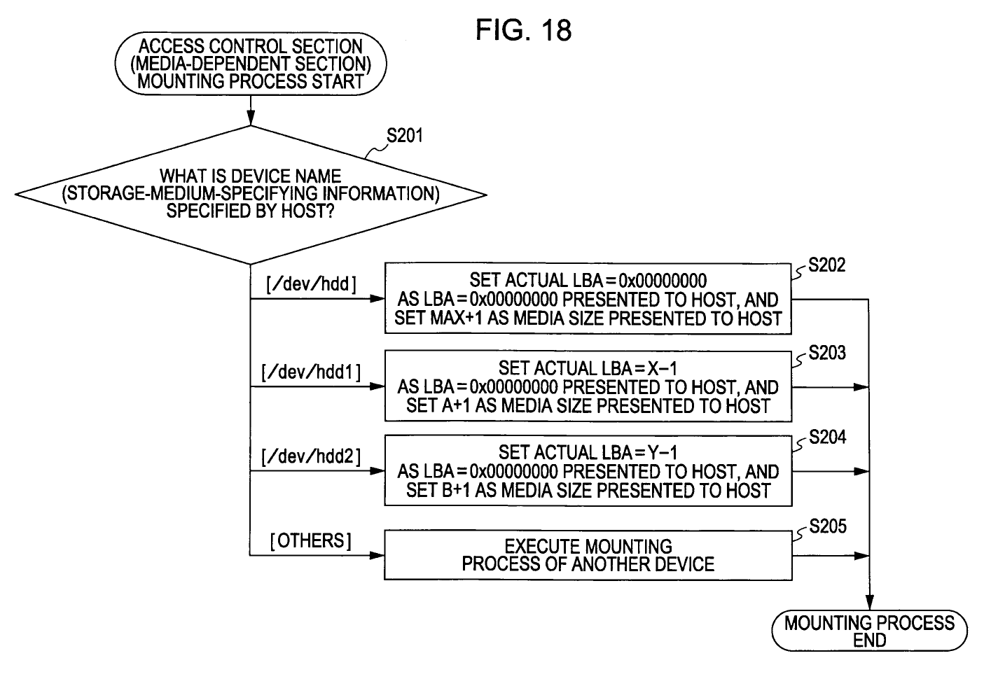

In the following, as the mounting process executed under the control of the access control section 340 shown in FIG. 10, a mounting process sequence on the media-independent recording/playback control section side, and a mounting process sequence on the media-dependent recording/playback control section side will be described with reference to FIGS. 16 and 18, respectively.

First, referring to the flow chart shown in FIG. 16, a description will be given of the mounting process sequence executed under the control of the access control section 340 on the media-independent recording/playback control section side.

In step S101, a device is opened by a device name (storage-medium-specifying information) designated by the host application. As described above with reference to FIG. 10, for example, the host application includes the following applications:

recording application;

playback application; and

USB connection application,

and is an execution program selected from any one of these applications.

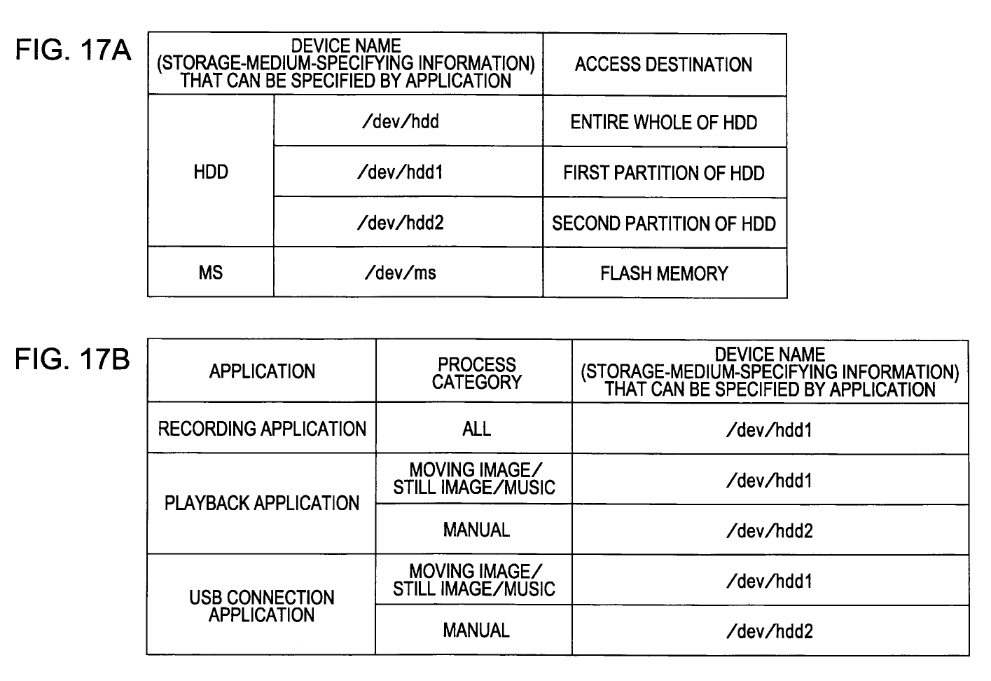

Devices that can be specified by these applications are set in advance. An example of this setting will be described with reference to FIGS. 17A and 17B. FIG. 17A is a diagram showing the correspondence between device names (storage-medium-specifying information) that can be specified by the application, and specific access destinations. FIG. 17B is a diagram showing the correspondence between the kinds of application, and devices (storage-medium-specifying information) that can be specified, which are set in advance with respect to the individual applications.

As shown in FIG. 17A, for example, the device names (storage-medium-specifying information) that can be specified by the application, and the specific access destinations are set as follows:

HDD [/dev/hdd]: Entire HDD (first and second partitions)

HDD [/dev/hdd1]: First partition of HDD

HDD [/dev/hdd2]: Second partition of HDD

MS [dev/ms]: Flash memory

Further, as shown in FIG. 17B, the correspondence between the kinds of application, and devices (storage-medium-specifying information) that can be specified, which are set in advance with respect to the individual applications, are as follows.

Recording application: [/dev/hdd1]

Playback application [Moving image/still image/music]: [/dev/hdd1]

Playback application [Manual]: [/dev/hdd2]

USB connection application [Moving image/still image/music]: [/dev/hdd1]

USB connection application [Manual]: [/dev/hdd2]

In this way, a device that can be specified by each application is set in advance. In the case of the playback application and the USB connection application, the device that can be specified can be switched over depending on the process category.

Returning to the flow in FIG. 16, further description will be continued with respect to the sequence of the mounting process. In step S101, a device is opened by the device name (storage-medium-specifying information) designated from the host application. This opening process involves recognition of a specified device, and setting of an access preparation state. If success of the opening process is confirmed in step S102, in step S103, reading of various kinds of information necessary for a data recording or playback process, such as file information or remaining-capacity information of specified media, is executed. The read information is held in, for example, the memory (RAM) 370 shown in FIG. 10.

Next, referring to FIG. 18, a description will be given of each mounting process sequence on the media-dependent media control section side. First, in step S201, a device name (storage-medium-specifying information) specified by the host application is checked. As described above with reference to FIG. 17B, a device (storage-medium-specifying information) that can be specified is set in advance for each of the recording, playback, and USB connection applications.

If a device name specified from the application is [/dev/hdd], the process proceeds to step S202. If the specified device name is [/dev/hdd1], the process proceeds to step S203. If the specified device name is [/dev/hdd2], the process proceeds to step S204. If the specified device name is other than these, the process proceeds to step S205.

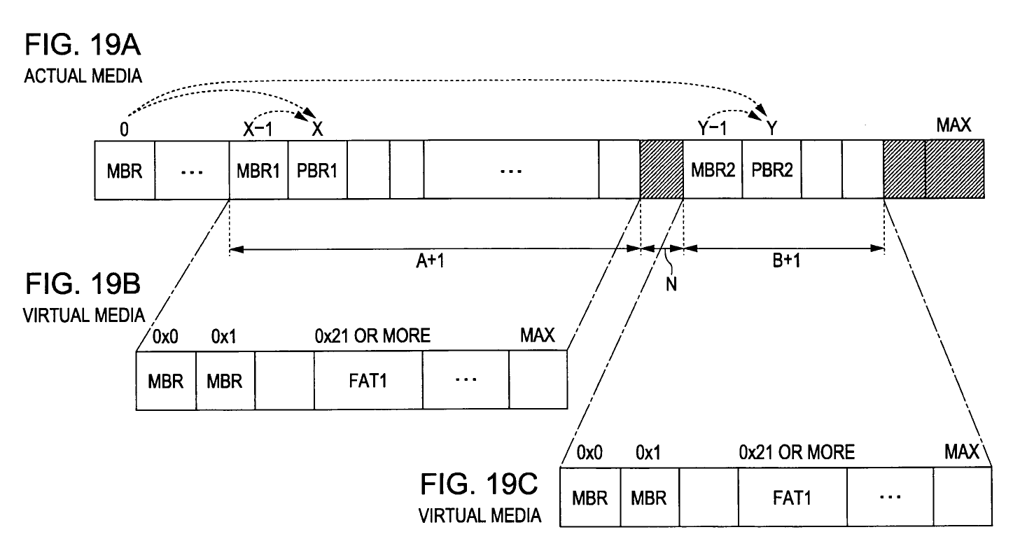

If the specified device name is [/dev/hdd], the process proceeds to step S202, where the logical block address: LBA=x0000000 that is the actual starting address of the entire HDD is set as the logical block address: LBA=0x00000000 to be presented to the host application, and further, the media size to be presented to the host application is set as MAX+1. That is, the whole media shown in FIG. 19A is presented to the application. The application can thus access the entire HDD shown in FIG. 19A, that is, the first partition and the second partition.

If the specified device name is [/dev/hdd1], the process proceeds to step S203, where the actual logical block address: LBA=X−1 is set as the logical block address: LBA=0x00000000 to be presented to the host application, and further, the media size to be presented to the host application is set as A+1. That is, the media area corresponding to the first partition shown in FIG. 19B is set as a virtual HDD to be presented to the application. The application can thus recognize the virtual HDD corresponding to the first partition shown in FIG. 19B, thus allowing access to only the first partition.

If the specified device name is [/dev/hdd2], the process proceeds to step S204, where the actual logical block address: LBA=Y−1 is set as the logical block address: LBA=0x00000000 to be presented to the host application, and further, the media size to be presented to the host application is set as B+1. That is, the media area corresponding to the second partition shown in FIG. 19C is set as a virtual HDD to be presented to the application. The application can thus recognize the virtual HDD corresponding to the second partition shown in FIG. 19C, thus allowing access to only the second partition.

If the specified device name is other than these, the process proceeds to step S205, where a mounting process for another device such as a flash memory is executed.

It should be noted that as described above with reference to FIGS. 6A to 8C, the values of X and Y used as the LBAs as start address information and of the sizes A and B, which are to be presented to the executing application in steps S202 to S204, are as follows, for example:

Start LBA of the first partition: X=0x0000003F

Start LBA of the second partition: Y=0x456789AB

Size of the first partition: A

Size of the second partition: B

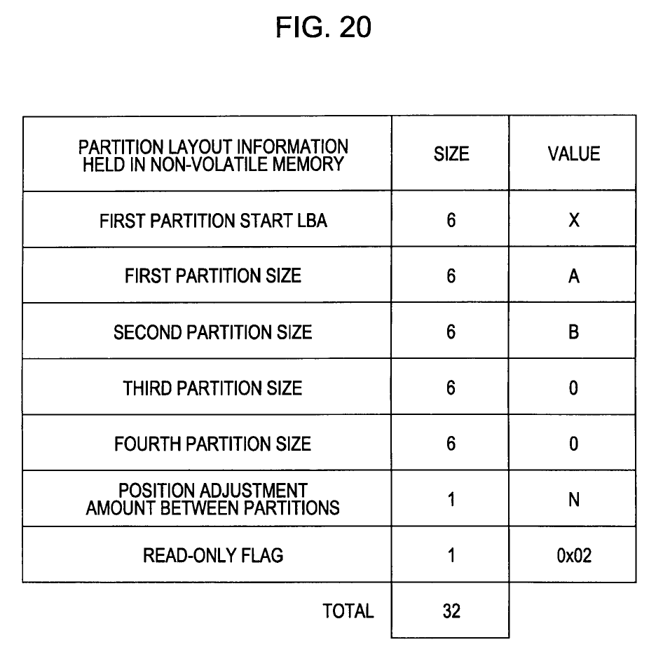

These values may be held in a non-volatile memory in advance so that calculation of LBAs is performed by using these values. Alternatively, only the minimum required information (partition layout information) may be held in the memory. For example, pieces of data as shown in FIG. 20 are stored in the non-volatile memory. That is, the following values:

Start LBA of the first partition: X

Size of the first partition: A

Size of the second partition: B

. . .

Size of the n-th partition:

Phase adjustment amount between partitions

Read-only flag

may be held in the memory so that the access control section calculates necessary values by using these pieces of information. For example, the start LBA=Y as the start address of the second partition is calculated as follows:

Y=X+A+N+1.

The read-only flag is a flag indicating whether or not each partition is set as read-only. This flag, which is referred to when there has been an input of a write command, is used for performing control as to whether or not to permit writing or the like. A process using this flag will be described later.

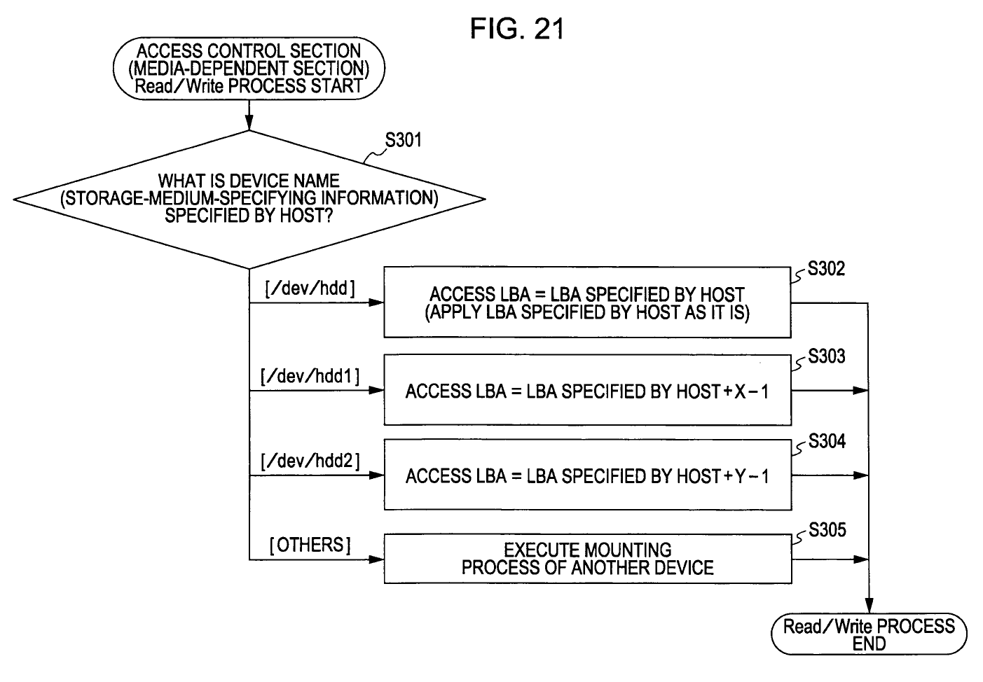

Next, referring to FIG. 21, a description will be given of the control sequence of a write or read process with respect to media (information recording medium) which is executed by the access control section 340 in the media control section (media-dependent section).

First, in step S301, a device name (storage-medium-specifying information) specified by the host application is checked. As described above with reference to FIG. 17B, a device (storage-medium-specifying information) that can be specified is set in advance for each of the recording, playback, and USB connection applications.

If the device name specified from the application is [/dev/hdd], the process proceeds to step S302. If the specified device name is [/dev/hdd1], the process proceeds to step S303. If the specified device name is [/dev/hdd2], the process proceeds to step S304. If the specified device name is other than these, the process proceeds to step S305.

If the specified device name is [/dev/hdd], the process proceeds to step S302, where access is executed while using the LBA specified from the host application as the logical block address LBA to be accessed as it is. In this case, the entire actual media shown in FIG. 19A is presented to the application, and reading of data from a specified address or writing of data to a specified address is executed by making access using the LBA specified by the application as the actual LBA as it is.

If the specified device name is [/dev/hdd1], the process proceeds to step S303, where the logical block address LBA to be accessed is calculated from the LBA specified from the host application. That is, by performing the following calculation:

LBA to be accessed=(LBA specified by application)+X−1, and access is executed by using the calculated LBA to be accessed.

In this case, the virtual HDD shown in FIG. 19B, that is, a virtual HDD including only the first partition is presented to the application.

At this time, X−1, which precedes X: the first partition's start LBA by one sector, is the position of MBR1 corresponding to the first partition. As the process for calculating the actual starting address of the first partition, the following calculation:

LBA to be accessed=(LBA specified by application)+X−1, is executed, and reading of data from a specified address or writing of data to a specified address is executed by making access using the calculated LBA to be accessed. Through this process, data recording or playback is executed only with respect to the first partition area by using the virtual HDD shown in FIG. 19B.

If the specified device name is [/dev/hdd2], the process proceeds to step S304, where the logical block address LBA to be accessed is calculated from the LBA specified from the host application. That is, by performing the following calculation:

LBA to be accessed=(LBA specified by application)+Y−1, and access is executed by using the calculated LBA to be accessed.

In this case, the virtual HDD shown in FIG. 19C, that is, a virtual HDD including only the second partition is presented to the application.

At this time, Y−1, which precedes Y: the second partition's start LBA by one sector, is the position of MBR2 corresponding to the second partition. As the process for calculating the actual starting address of the second partition, the following calculation:

LBA to be accessed=(LBA specified by application)+Y−1, is executed, and reading of data from a specified address or writing of data to a specified address is executed by making access using the calculated LBA to be accessed. Through this process, data recording or playback is executed only with respect to the second partition area by using the virtual HDD shown in FIG. 19C.

If the specified device name is other than these, the process proceeds to step S305, and a data writing or reading process using another device, such as a flash memory, is executed.

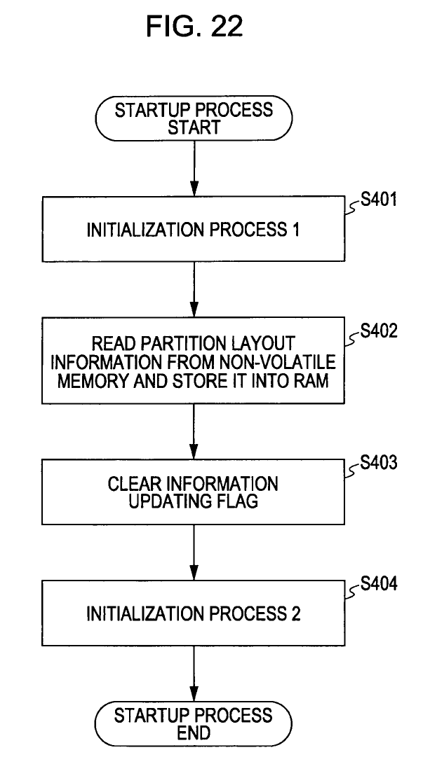

Next, referring to the flow charts in FIGS. 22 to 24, a description will be given of the sequences of a startup process and termination process executed by the access control section.

First, the sequence of the startup process will be described with reference to FIG. 22. The startup process is executed at the startup of the information processing apparatus. First, in step S401, as Initialization Process 1, for example, a process of determining the kind of loaded media, and acquiring the format information of the determined media is executed. In step S402, the layout information described above with reference to FIG. 20 is read from the non-volatile memory, and held in a RAM as a work area memory.

Further, in step S403, an information updating flag is cleared. This information updating flag is cleared if it has been confirmed that the partition layout information held in the non-volatile memory matches the partition layout information of the currently loaded media, and is placed in a set state while an update is being performed. Next, in step S404, as Initialization Process 2, the final process required for entering a standby state waiting for a command input from the host application is executed. Thereafter, a command from the application is inputted, thus making it possible to execute a process according to this input.

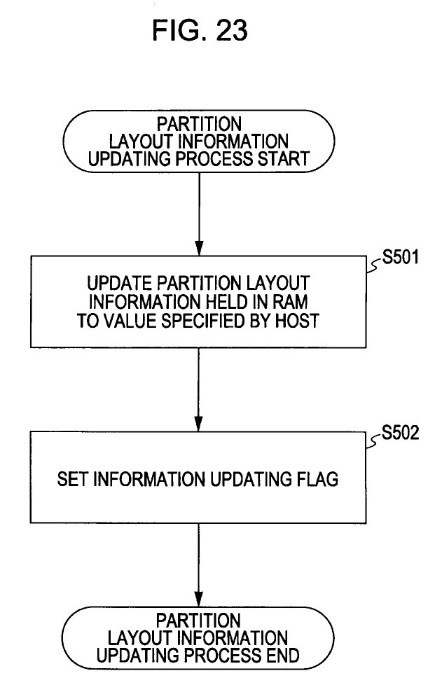

Next, referring to FIG. 23, a description will be given of the process sequence when changing partition layout information. While a format example in which two partitions are set is described above with reference to FIG. 5, it is possible to change the partition layout by, for example, executing a reformatting process. Specifically, a process such as setting three partitions is possible. The flow shown in FIG. 23 illustrates the process sequence when changing the partition layout in this way.

First, in step S501, each value of the partition layout information (see FIG. 20) held in the RAM serving as a work memory is changed to the value specified by a host application. It should be noted that this application is an application that executes setting of partitions or the like, and is different from the recording, playback, and USB connection applications described above with reference to FIG. 10. In step S502, the information updating flag is set. Thereafter, a partition setting process is executed as the formatting process with respect to the actual media.

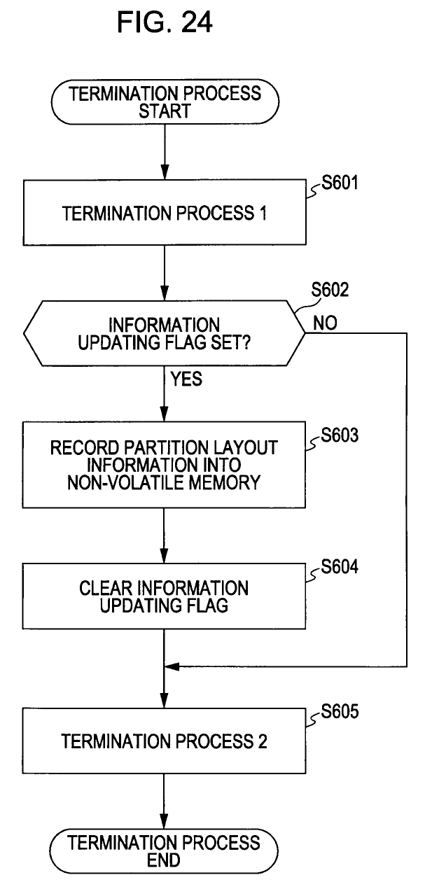

The termination sequence for a media formatting process will be described with reference to the flow chart in FIG. 24. First, Termination Process 1 is executed in step S601. This process checks whether or not a formatting process with respect to media has been completed. Next, in step S602, it is checked whether or not the information updating flag has been set. As described above, this information updating flag is cleared if it has been confirmed that the partition layout information held in the non-volatile memory matches the partition layout information of the currently loaded media, and is placed in a set state while an update is being performed.

If the information updating flag has been set, the process proceeds to step S603, where the updated partition layout information is recorded into the non-volatile memory, and in step S604, the information updating flag is cleared. In step S605, Termination Process 2, that is, a process of executing a check as to whether or not the entire formatting process has been completed, and making a setting allowing a shift to the next process, is performed, and the process is terminated.

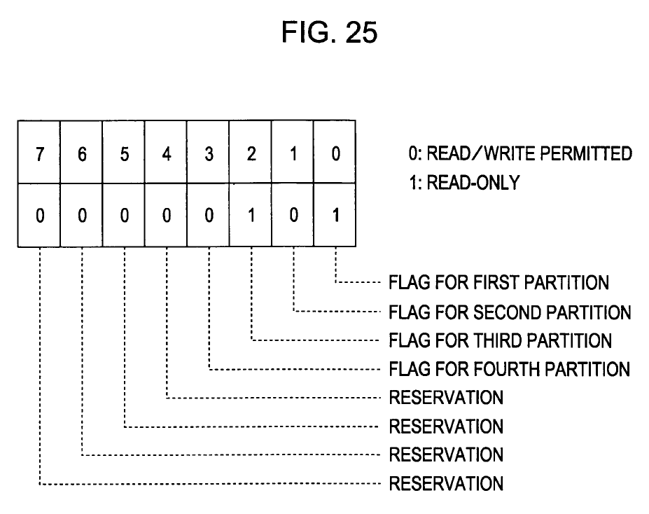

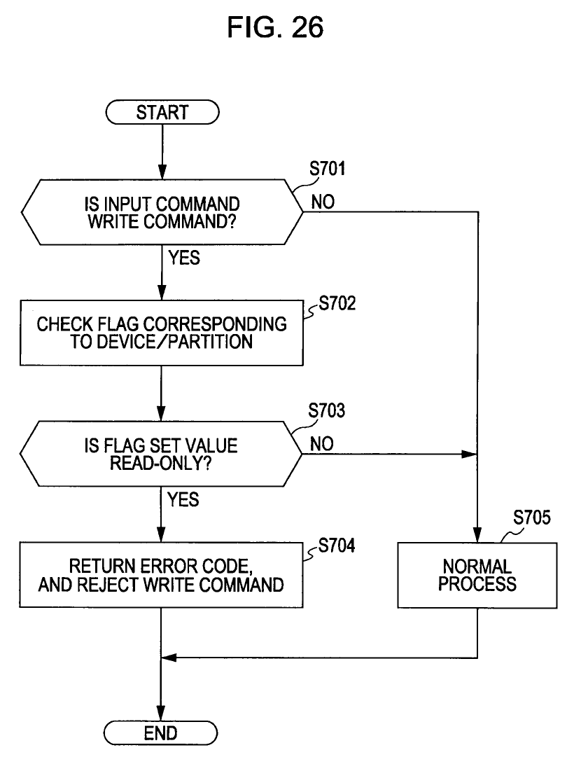

Next, referring to FIGS. 25 and 26, a description will be given of a process executed by the access control section 340 when a write command is inputted from an application. This process is a write control performed by determining whether writing of data to a partition is permitted or not permitted by referring to the read-only flag in the partition layout information described above with reference to FIG. 20.

As shown in FIG. 25, the read-only flag is a flag set for each partition to indicate whether or not each partition is set so as to permit reading and writing of data or is set as read-only not permitting writing of data.

When a data write command from the application is inputted, the access control section 340 refers to this flag to determine whether data writing is permitted or not. The sequence of this control will be described with reference to the flow chart shown in FIG. 26.

First, in step S701, it is determined whether or not an input command from the application is a data write command. If the input command is not a data write command, the process proceeds to step S705, where a normal process according to the command is executed.

If the input command from the application is a data write command, the process proceeds to step S702, where the flag shown in FIG. 25 is checked. This flag check is executed as a process of checking a flag corresponding to a device specified from the application.

In step S703, if it is determined that the flag corresponding to a device specified from the application indicates read-only, the process proceeds to step S704, where an error code is outputted to the application, rejecting a write command. If it is determined in step S703 that the flag corresponding to a device specified from the application does not indicate read-only, the process proceeds to step S705, where a data write process is executed in accordance with a request from the application. By performing a write control by referring to this flag, erroneous data writing is prevented.

[5. Example of Hardware Configuration of Information Processing Apparatus]

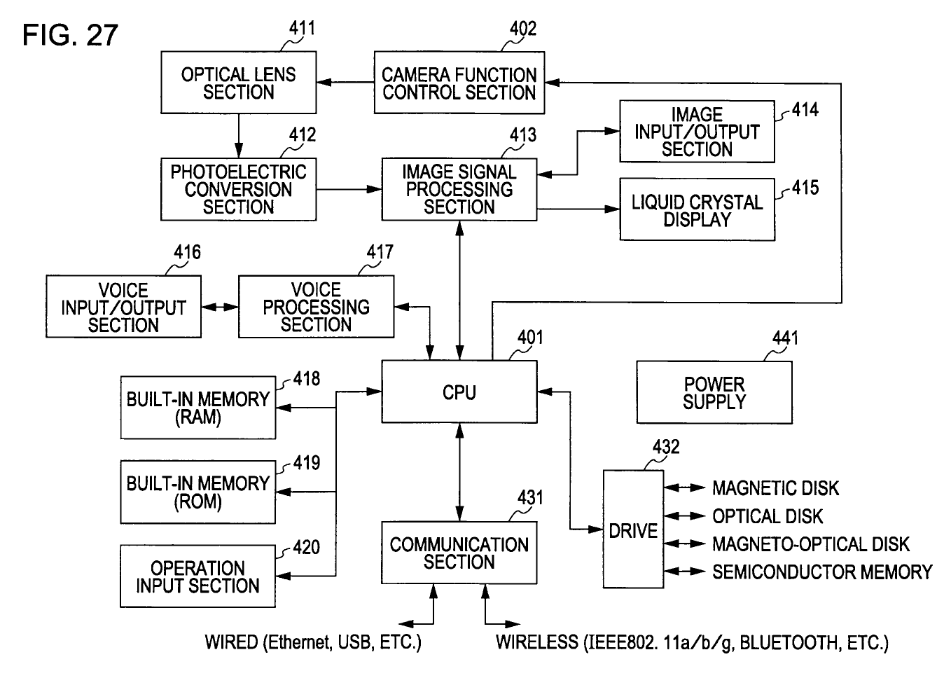

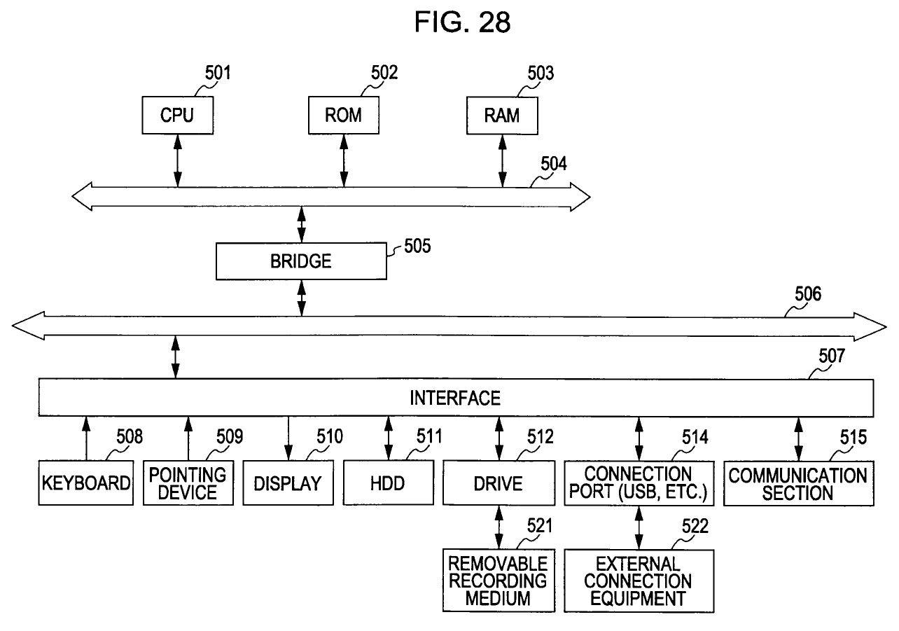

Next, as an example of the configuration of the information processing apparatus that executes the above-described processes, exemplary configurations of a digital video camera and a PC will be described with reference to FIGS. 27 and 28.

First, an example of the configuration of a digital video camera will be described with reference to FIG. 27. A digital video camera operates in one of: an image capture mode of capturing an image and recording image data obtained by the image capture onto various types of information recording medium, such as a magnetic disk, an optical disk, a magneto-optical disk, or a semiconductor memory, via a drive 432; and a VTR mode of recording data supplied via an image input/output section 414, a voice input/output section 416, or a communication section 431 onto a recording medium or playing back data recorded on the recording medium.

The image capture mode includes a moving image capture mode of capturing moving images and recording the images together with voice collected simultaneously with this image capture onto a recording medium; and a still image capture mode of capturing still images. In the VTR mode, supplied data is recorded by operating an operation input section 420 including a recording button switch or the like, and desired data recorded on the recording medium can be played back by operating a playback button switch.

As shown in FIG. 27, the digital video camera includes an optical lens section 411, a photoelectric conversion section 412, a camera function control section 402, an image signal processing section 413, the image input/output section 414, a liquid crystal display 415, the voice input/output section 416, a voice signal processing section 417, the communication section 431, a control section (CPU) 401, a built-in memory (RAM) 418, a built-in memory (ROM) 419, an operation input section 420, the drive 432 for an information recording medium, and a power supply 441 that supplies electric power to each section.

The control section (CPU) 401 performs processes in accordance with various process programs stored in the ROM 419. The RAM 418 is mainly used as a work area for temporarily storing the result of each process in progress, or the like. A process using the partition layout information held in the RAM 418 is also executed during the above-described partition-specific process.

The operation input section 420 includes various operation keys and function keys, e.g., a mode switching key for switching between operation modes such as a moving image shooting mode, a still image shooting mode, and a VTR mode, a shutter key for shooting still images, a shooting start key for shooting moving images, a recording key, a playback key, a stop key, a fast-forward key, and a fast-rewind key. The operation input section 420 accepts an operation input by the user, and supplies an electric signal corresponding to the accepted operation input to the control section (CPU) 401.

In accordance with an operation input from the user, the control section (CPU) 401 reads a program for performing an intended process from the ROM 419 and executes the program, and controls each section so as to perform control of a process according to an instruction from the user. Various kinds of information recording medium, such as a magnetic disk, an optical disk, a magneto-optical disk, and a semiconductor memory, can be loaded in the digital video camera. The digital video camera records various kinds of information on these types of recording medium via the drive 432, and plays back information recorded on these types of recording medium. A hard disk as the magnetic disk has, for example, the layout described above with reference to FIG. 5.

Next, referring to FIG. 28, a description will be given of an example of the hardware configuration of a PC as an example of the information processing apparatus that executes the above-described processes. A CPU (Central Processing Unit) 501 functions as a data processing section that executes a process corresponding to an OS (Operating System), the partition-specific data recording or data playback process described with respect to the embodiment described above, and the like. These processes are executed in accordance with a computer program that is stored in a data storing section, such as a ROM or a hard disk, of the information processing apparatus.

A ROM (Read Only Memory) 502 stores programs, calculation parameters, and the like used by the CPU 501. A RAM (random access memory) 503 stores programs used for the execution of the CPU 501, parameters that vary during the execution, the above-described partition layout information, and the like. The CPU 501, the ROM 502, and the RAM 503 are connected to each other via a host bus 504 formed by a CPU bus or the like. During the recording process of the management information described above as well, updating of data or the like is executed with the RAM 503 as a working area.

The host bus 504 is connected to an external bus 506 such as a PCI (Peripheral Component Interconnect/Interface) bus or the like, via a bridge 505.

A keyboard 508 and a pointing device 509 are input devices operated by the user. A display 510 is formed by a liquid crystal display device, a CRT (Cathode Ray Tube), or the like, and displays various kinds of information in text or image form.

A HDD (Hard Disk Drive) 511 has a hard disk built therein, and drives the hard disk. The hard disk has, for example, the layout described above with reference to FIG. 5. Further, the hard disk is used as a storage area for an image data file, and stores various computer programs, such as a data processing program.

A drive 512 reads data or a program recorded on a removable recording medium 521 such as a magnetic disk, an optical disk, a magneto-optical disk, or a semiconductor memory, and supplies the data or the program to the RAM 503 connected to the drive 512 via an interface 507, the external bus 506, the bridge 505, and the host bus 504.

A connection port 514 is a port for connection to external connection equipment 522, and includes a connection section such as a USB, IEEE1394, or the like. The connection port 514 is connected to the CPU 501 and the like via the interface 507, the external bus 506, the bridge 505, the host bus 504, and the like. A communication section 515 is connected to a network, and executes communication with another information processing apparatus.

The configuration of the information processing apparatus shown in each of FIGS. 27 and 28 is merely an example of the apparatus. The configuration of the information processing apparatus is not limited to those shown in FIGS. 27 and 28, but any configuration may be applied as long as the information processing apparatus can execute the processes described in the above-mentioned embodiment.

While the present invention is applicable to a wide range of randomly accessible media, it can be said that the present invention proves particularly effective when applied to a HDD (Hard Disk Drive). Further, the file system is not limited to FAT16/32.

The present invention has been described above in detail with reference to a specific embodiment. However, it is obvious that those skilled in the art can made various modifications and alterations to the embodiment without departing from the scope of the present invention. That is, the present invention has been disclosed for illustrative purposes only and should not be interpreted in a restrictive manner. The scope of the present invention should be determined by reference to the appended claims.

The series of processes described in this specification can be executed by hardware, software, or a composite configuration of both. If the series of processes is to be executed by software, the series of processes can be executed by installing a program recording the process sequence into a memory of a computer built in dedicated hardware, or by installing the program into a general purpose computer capable of executing various processes.

For example, the program may be stored in advance in a hard disk or a ROM (Read Only Memory) as a recording medium. Alternatively, the program may be stored (recorded) temporarily or permanently in a removable recording medium such as a flexible disk, a CD-ROM (Compact Disc Read Only Memory), an MO (Magneto-optical) disk, a DVD (Digital Versatile Disc), a magnetic disk, and a semiconductor memory. Such a removable recording medium can be provided in the form of so-called package software.

Other than being installed into a computer from the above-described removable recording medium, the program can be wireless-transferred to a computer from a download site, or wire-transferred to a computer via a network such as a LAN (Local Area Network) or the Internet. The computer receives the program thus transferred and installs the program into a built-in recording medium such as a hard disk.

The various processes described in this specification may be executed not only time sequentially in the order as they appear in the description but may be executed in parallel or independently depending on the throughput of the apparatus executing the processes. Further, the term system as used in this specification refers to a logical assembly of a plurality of apparatuses, and is not limited to one in which respective apparatuses are located within the same housing.

As described above, according to an embodiment of the present invention, a configuration is realized where a partition within the information recording medium to which access is permitted can be varied in accordance with the application executed in the information processing apparatus, for example, a recording application, a playback application, or an external equipment connection application. For example, the access control section changes access information such as a start address in accordance with the application, and provides the access information to the application. According to this configuration, it is possible to perform access control according to the application to be executed, such as disabling access from the recording application to data whose erroneous deletion should be prevented, such as a manual.

What is claimed is:

1. An information processing apparatus comprising:
an application executing section that executes a data recording or playback process with respect to an information recording medium;
an access control section that receives information-recording-medium-specifying information from an executing application in the application executing section, generates access information corresponding to the received information-recording-medium-specifying information, and presents the access information to the executing application; and
a device driver that executes access to the information recording medium,
wherein the access control section performs a process of generating access information corresponding to the whole or only a part of a plurality of partitions set on the information recording medium and presenting the access information to the executing application, in accordance with the information-recording-medium-specifying information received from the executing application.

2. The information processing apparatus according to claim 1, wherein:
the access control section performs a process of presenting start address information, which varies in accordance with the information-recording-medium-specifying information received from the executing application, to the executing application.

3. The information processing apparatus according to claim 1, wherein:
the access control section performs a process of receiving the information-recording-medium-specifying information corresponding to the whole or a part of the partitions of the information recording medium as the information-recording-medium-specifying information from the executing application, and presenting start address information corresponding to the whole or a part of the partitions of the information recording medium to the executing application in accordance with the received information-recording-medium-specifying information.

4. The information processing apparatus according to claim 3, wherein:
the access control section performs a process of presenting a starting logical block address (LBA) corresponding to the whole or a part of the partitions of the information recording medium to the executing application as the start address information corresponding to the whole or a part of the partitions of the information recording medium.

5. The information processing apparatus according to claim 1, wherein:
the application executing section is capable of selecting as the executing application at least one of a recording application that executes data recording, a playback application that executes data playback, and a connection application that executes processing by external connection equipment;
for each of the recording application, the playback application, and the connection application, the information-recording-medium-specifying information that can be used is set in advance; and
the access control section performs a process of presenting start address information corresponding to the whole or a part of the partitions of the information recording medium to the executing application, in accordance with the information-recording-medium-specifying information specified by one of the recording application, the playback application, and the connection application.

6. The information processing apparatus according to claim 5, wherein:
for the playback application, the information-recording-medium-specifying information that can be used is set in advance in accordance with a playback category indicating the kind of data to be played back; and
the access control section performs a process of presenting the start address information corresponding to the whole or a part of the partitions of the information recording medium to the executing application, in accordance with the information-recording-medium-specifying information determined in accordance with the playback category of the playback application.

7. The information processing apparatus according to claim 5, wherein:
for the connection application, the information-recording-medium-specifying information that can be used is set in advance in accordance with a process category indicating the kind of data to be processed; and
the access control section performs a process of presenting the start address information corresponding to the whole or a part of the partitions of the information recording medium to the executing application, in accordance with the information-recording-medium-specifying information determined in accordance with the process category of the connection application.

8. The information processing apparatus according to claim 1, wherein:
the access control section performs a process of setting virtual media corresponding to the whole or only a part of the plurality of partitions set on the information recording medium and presenting the virtual media to the executing application, in accordance with the information-recording-medium-specifying information received from the executing application.

9. The information processing apparatus according to claim 8, wherein:
for each of the partitions of the information recording medium, a partition-specific master boot record (MBR) as partition-specific access information is set individually; and
the access control section performs a process of, when presenting only a part of the partitions to the executing application in accordance with the information-recording-medium-specifying information received from the executing application, setting the virtual media including the partition-specific master boot record (MBR) and presenting the virtual media to the executing application.

10. The information processing apparatus according to claim 1, further comprising a storage section that stores partition layout information of the information recording medium, wherein:
the access control section executes an updating process of the partition layout information recorded in the storage section when changing partition layout of the information recording medium.

11. The information processing apparatus according to claim 10, wherein:
the partition layout information recorded in the storage section includes information that allows calculation of a start address and partition size of each of the partitions set on the information recording medium; and
the access control section performs a process of generating the access information by applying the partition layout information recorded in the storage section, and presenting the access information to the executing application.

12. An information recording medium comprising:
a plurality of partitions serving as a plurality of data recording areas; and
a partition-specific master boot record (MBR) dedicated to each of the partitions,
wherein the information recording medium allows access using information recorded in the partition-specific master boot record (MBR).

13. The information recording medium according to claim 12, wherein the partition-specific master boot record (MBR) records a partition table for only a corresponding partition which records a start sector address and size information of the corresponding partition.

14. An information processing apparatus which executes formatting of an information recording medium, comprising:
a data processing section that executes formatting in which a plurality of partitions serving as a plurality of segmented data recording areas are set, and a partition-specific master boot record (MBR) dedicated to each of the partitions is recorded in each of the partitions.

15. The information processing apparatus according to claim 14, wherein:
the data processing section executes a process of recording in the partition-specific master boot record (MBR) a partition table for only a corresponding partition which records a start sector address and size information of the corresponding partition.

16. An information processing method for executing access control with respect to an information recording medium in an information processing apparatus, comprising:
an application executing step of causing an application executing section to execute a data recording or playback process with respect to the information recording medium; and
an access control step of causing an access control section to receive information-recording-medium-specifying information from an executing application in the application executing step, generate access information corresponding to the received information-recording-medium-specifying information, and present the access information to the executing application,
wherein the access control step performs a process of generating access information corresponding to the whole or only a part of a plurality of partitions set on the information recording medium and presenting the access information to the executing application, in accordance with the information-recording-medium-specifying information received from the executing application.

17. The information processing method according to claim 16, wherein:
the access control step performs a process of presenting start address information, which varies in accordance with the information-recording-medium-specifying information received from the executing application, to the executing application.

18. The information processing method according to claim 16, wherein:
the access control step performs a process of receiving the information-recording-medium-specifying information corresponding to the whole or a part of the partitions of the information recording medium as the information-recording-medium-specifying information from the executing application, and presenting start address information corresponding to the whole or a part of the partitions of the information recording medium to the executing application in accordance with the received information-recording-medium-specifying information.

19. The information processing method according to claim 18, wherein:
the access control step performs a process of presenting a starting logical block address (LBA) corresponding to the whole or a part of the partitions of the information recording medium to the executing application as the start address information corresponding to the whole or a part of the partitions of the information recording medium.

20. The information processing method according to claim 16, wherein:
the application executing step is a step of selecting and executing as the executing application at least one of a recording application that executes data recording, a playback application that executes data playback, and a connection application that executes processing by external connection equipment, and for each of the recording application, the playback application, and the connection application, the information-recording-medium-specifying information that can be used is set in advance; and
the access control step performs a process of presenting start address information corresponding to the whole or a part of the partitions of the information recording medium to the executing application, in accordance with the information-recording-medium-specifying information specified by one of the recording application, the playback application, and the connection application.

21. The information processing method according to claim 20, wherein:
for the playback application, the information-recording-medium-specifying information that can be used is set in advance in accordance with a playback category indicating the kind of data to be played back; and
the access control step performs a process of presenting the start address information corresponding to the whole or a part of the partitions of the information recording medium to the executing application, in accordance with the information-recording-medium-specifying information determined in accordance with the playback category of the playback application.

22. The information processing method according to claim 20, wherein:
for the connection application, the information-recording-medium-specifying information that can be used is set in advance in accordance with a process category indicating the kind of data to be processed; and
the access control step performs a process of presenting the start address information corresponding to the whole or a part of the partitions of the information recording medium to the executing application, in accordance with the information-recording-medium-specifying information determined in accordance with the process category of the connection application.

23. The information processing method according to claim 16, wherein:
the access control step performs a process of setting virtual media corresponding to the whole or only a part of the plurality of partitions set on the information recording medium and presenting the virtual media to the executing application, in accordance with the information-recording-medium-specifying information received from the executing application.

24. The information processing method according to claim 23, wherein:
for each of the partitions of the information recording medium, a partition-specific master boot record (MBR) as partition-specific access information is set individually; and
the access control step performs a process of, when presenting only a part of the partitions to the executing application in accordance with the information-recording-medium-specifying information received from the executing application, setting the virtual media including the partition-specific master boot record (MBR) and presenting the virtual media to the executing application.

25. The information processing method according to claim 16, wherein:
the information processing apparatus has a storage section that stores partition layout information of the information recording medium; and
the information processing method further comprises a step of executing an updating process of the partition layout information recorded in the storage section when changing partition layout of the information recording medium.

26. The information processing method according to claim 25, wherein:
the partition layout information recorded in the storage section includes information that allows calculation of a start address and partition size of each of the partitions set on the information recording medium; and
the access control step performs a process of generating the access information by applying the partition layout information recorded in the storage section, and presenting the access information to the executing application.

27. An information processing method for executing formatting of an information recording medium in an information processing apparatus, comprising:
a data processing step of causing a data processing section to execute formatting in which a plurality of partitions serving as a plurality of segmented data recording areas are set, and a partition-specific master boot record (MBR) dedicated to each of the partitions is recorded in each of the partitions.

28. The information processing method according to claim 27, wherein:
the data processing section records in the partition-specific master boot record (MBR) a partition table for only a corresponding partition which records a start sector address and size information of the corresponding partition.

29. A computer program for causing access control with respect to an information recording medium to be executed in an information processing apparatus, comprising:
an application executing step of causing an application executing section to execute a data recording or playback process with respect to the information recording medium; and
an access control step of causing an access control section to receive information-recording-medium-specifying information from an executing application in the application executing step, generate access information corresponding to the received information-recording-medium-specifying information, and present the access information to the executing application,
wherein the access control step performs a process of causing access information corresponding to the whole or a part of a plurality of partitions set on the information recording medium to be generated and presented to the executing application, in accordance with the information-recording-medium-specifying information received from the executing application.

30. A computer program for causing formatting of an information recording medium to be executed in an information processing apparatus, comprising:
a data processing step of causing a data processing section to execute formatting in which a plurality of partitions serving as a plurality of segmented data recording areas are set, and a partition-specific master boot record (MBR) dedicated to each of the partitions is recorded in each of the partitions.
